(19) United States
(12) Patent Application Publication
(10) Pub. No.: US 2026/0367749 A1
(43) Pub. Date: Nov. 19, 2026

(54) SYSTEMS AND METHODS OF FILTERING MOTION OF A VIRTUAL CONTENT WINDOW BASED ON USER MOVEMENT

(71) Applicant: Apple Inc., Cupertino, CA (US)

(72) Inventors: Yirong TANG, Sunnyvale, CA (US); Daniel J. BREWER, Redwood City, CA (US)

(21) Appl. No.: 19/643,595

(22) Filed: Apr. 9, 2026

Related U.S. Application Data
(60) Provisional application No. 63/819,407, filed on Jun. 6, 2025.
(60) Provisional application No. 63/805,043, filed on May 13, 2025.

(51) Int. Cl. G06F 3/04815; G06T 7/73

(52) U.S. Cl. CPC G06F 3/04815; G06T 7/73

(57) ABSTRACT

Some examples of the disclosure are directed to a method of filtering unwanted motion of a virtual content window based on user movement. The method can include detecting a pose vector of the electronic device in either the pitch or yaw dimension that includes detecting a head vector and a torso vector of the user of the electronic device. The electronic device can display virtual content at a position in the three-dimensional environment relative to the pose vector and can move the position of the virtual content in accordance with movement of the pose vector. The pose vector may only move when both the head and torso vector are aligned and moving simultaneously.

### CROSS REFERENCE TO RELATED APPLICATIONS

This application claims the benefit of U.S. Provisional Application No. 63/819,407, filed Jun. 6, 2025, and U.S. Provisional Application No. 63/805,043, filed May 13, 2025, the contents of which are herein incorporated by reference in their entireties for all purposes.

### FIELD OF THE DISCLOSURE

This relates generally to systems and methods for filtering unwanted motion of a window displaying virtual content to a user while the user moves around a three-dimensional environment.

### BACKGROUND OF THE DISCLOSURE

The development of computer systems for augmented reality has increased significantly in recent years. Example augmented reality environments include at least some virtual elements that replace or augment the physical world. Input devices, such as cameras, controllers, joysticks, touch-sensitive surfaces, and touch-screen displays for computer systems and other electronic computing devices are used to interact with virtual/augmented reality environments. Example virtual elements include virtual objects, such as digital images, video, text, icons, and control elements such as buttons and other graphics.

### SUMMARY OF THE DISCLOSURE

Some computer graphical environments provide two-dimensional (2D) and/or three-dimensional (3D) environments where at least some objects displayed for a user’s viewing are virtual and generated by a computer. In some examples, an electronic device in communication with one or more display devices and one or more input devices detects a trajectory of a user of the device in a three-dimensional environment. When the electronic device detects that the trajectory satisfies a first specific set of conditions, the device operates in a first orientation mode that moves the location of the virtual content in the three-dimensional environment in accordance with the trajectory of the user. When the electronic device detects that the trajectory satisfies a second specific set of conditions, different from the first specific set of conditions, the electronic device will transition to a second orientation mode. This second orientation mode includes moving the virtual content in the three-dimensional environment in accordance with the trajectory of the user and in accordance with rotation of the user in the three-dimensional environment.

Some computer graphical environments provide two-dimensional (2D) and/or three-dimensional (3D) environments where at least some objects displayed for a user’s viewing are virtual and generated by a computer. In some examples, an electronic device in communication with one or more display devices and one or more input devices detects a head orientation and a torso and/or trajectory orientation of a user of the device in a three-dimensional environment, which are both used to track an overall pose vector of the user. In some examples, the pose vector of the user controls the location of where virtual content is displayed in the environment to the user. When the electronic device detects that the head vector or the torso/trajectory vector satisfies a first specific set of conditions, the device updates the pose vector, and ultimately the position of the virtual content, in accordance with the aligned movement of the head vector and the torso vector. When the electronic device detects that the head vector or the torso/trajectory vector do not satisfy a first specific set of conditions, the device continues to display the virtual content at the last position that the pose vector was updated to.

The full descriptions of these examples are provided in the Drawings and the Detailed Description, and it is understood that this Summary does not limit the scope of the disclosure in any way.

### BRIEF DESCRIPTION OF THE DRAWINGS

For improved understanding of the various examples described herein, reference should be made to the Detailed Description below along with the following drawings. Like reference numerals often refer to corresponding parts throughout the drawings.

FIG. 1 illustrates an electronic device presenting a three-dimensional environment according to some examples of the disclosure.

FIGS. 2A-2B illustrate block diagrams of example architectures for electronic devices according to some examples of the disclosure.

FIG. 3 illustrates an exemplary three-dimensional environment displayed using one or more displays of an electronic device according to examples of the disclosure.

FIG. 4 illustrates a flow chart of a method for transitioning between the orientation modes the electronic device uses to display virtual content while the user is moving in accordance with some examples of the disclosure.

FIGS. 5A-5F illustrate electronic device displaying virtual content in the various orientation modes according to some examples of the disclosure.

FIG. 6 illustrates a flow diagram illustrating an example process for filtering unwanted motion of a virtual content window based on user movement according to some examples of the disclosure.

FIG. 7 illustrates an exemplary three-dimensional environment displayed using one or more displays of an electronic device according to examples of the disclosure.

FIGS. 8A-8D illustrate sequential top-down views of the user of electronic device while moving (e.g., rotating) in the yaw dimension and in the three-dimensional environment while the electronic device detects the torso of the user with high confidence according to some examples of the disclosure.

FIGS. 9A-9E illustrate sequential top-down views of the user of electronic device while moving (e.g., rotating) in the yaw dimension and in the three-dimensional environment while the electronic device detects the torso of the user with low confidence according to examples of the disclosure.

FIGS. 10A-10F illustrate sequential side views of the user of electronic device while moving (e.g., rotating) in the pitch dimension and in the three-dimensional environment while the electronic device detects the torso of the user with high confidence according to some examples of the disclosure.

FIGS. 11A-11E illustrate sequential side views of the user of electronic device while moving (e.g., rotating) in the pitch dimension and in the three-dimensional environment while the electronic device detects the torso of the user with low confidence according to examples of the disclosure.

FIG. 12 illustrates a flow diagram illustrating an example process for filtering unwanted motion of a virtual content window based on user movement according to some examples of the disclosure.

### DETAILED DESCRIPTION

Some computer graphical environments provide two-dimensional (2D) and/or three-dimensional (3D) environments where at least some objects displayed for a user’s viewing are virtual and generated by a computer. In some examples, an electronic device in communication with one or more display devices and one or more input devices detects a trajectory of a user of the device in a three-dimensional environment. When the electronic device detects that the trajectory satisfies a first specific set of conditions, the device operates in a first orientation mode that moves the location of the virtual content in the three-dimensional environment in accordance with the trajectory of the user. When the electronic device detects that the trajectory satisfies a second specific set of conditions, different from the first specific set of conditions, the electronic device will transition to a second orientation mode. This second orientation mode includes moving the virtual content in the three-dimensional environment in accordance with the trajectory of the user and in accordance with rotation of the user in the three-dimensional environment.

Some computer graphical environments provide two-dimensional (2D) and/or three-dimensional (3D) environments where at least some objects displayed for a user’s viewing are virtual and generated by a computer. In some examples, an electronic device in communication with one or more display devices and one or more input devices detects a head orientation and a torso and/or trajectory orientation of a user of the device in a three-dimensional environment, which are both used to track an overall pose vector of the user. In some examples, the pose vector of the user controls the location of where virtual content is displayed in the environment to the user. When the electronic device detects that the head vector or the torso/trajectory vector satisfies a first specific set of conditions, the device updates the pose vector, and ultimately the position of the virtual content, in accordance with the aligned movement of the head vector and the torso vector. When the electronic device detects that the head vector or the torso/trajectory vector do not satisfy a first specific set of conditions, the device continues to display the virtual content at the last position that the pose vector was updated to.

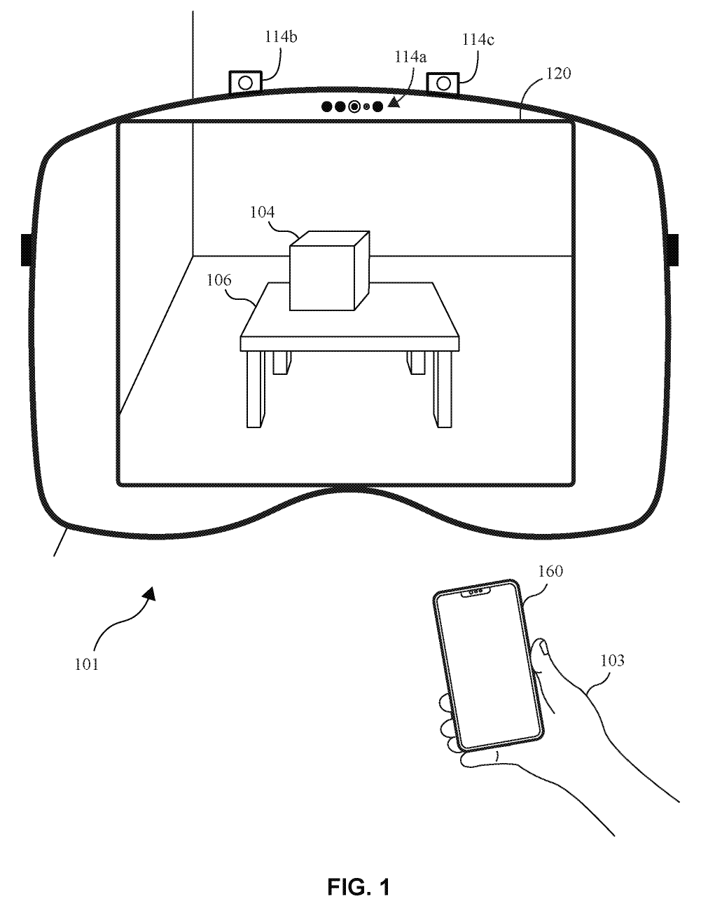

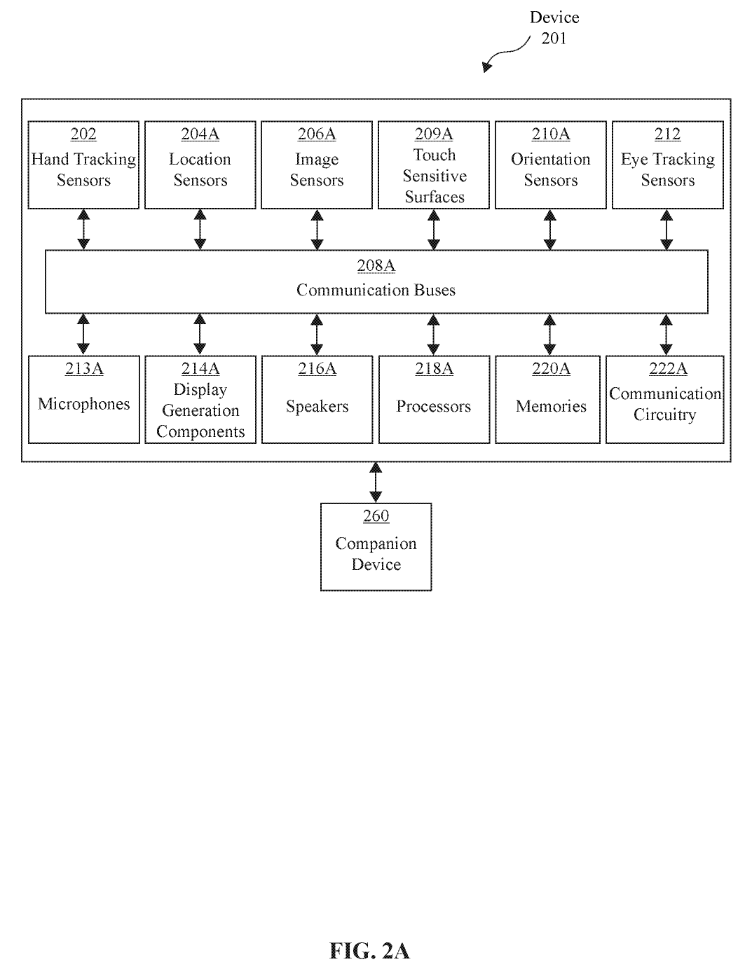

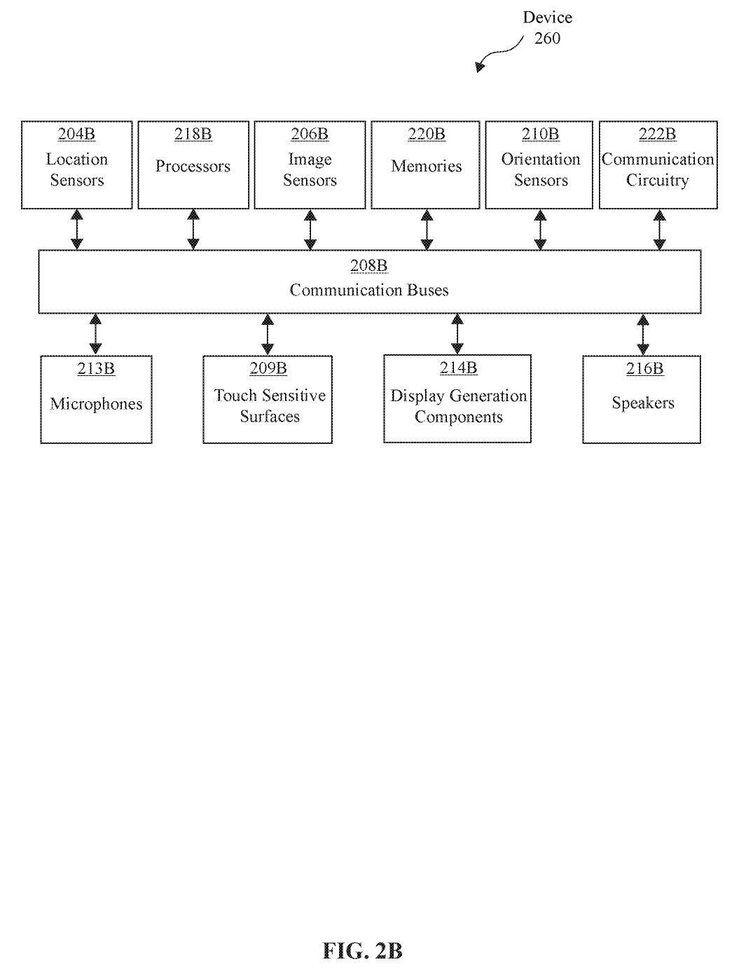

FIG. 1 illustrates an electronic device 101 presenting three-dimensional environment (e.g., an extended reality (XR) environment or a computer-generated reality (CGR) environment, optionally including representations of physical and/or virtual objects), according to some examples of the disclosure. In some examples, as shown in FIG. 1, electronic device 101 is a head-mounted display or other head-mountable device configured to be worn on a head of a user of the electronic device 101. Examples of electronic device 101 are described below with reference to the architecture block diagram of FIG. 2A. As shown in FIG. 1, electronic device 101 and table 106 are located in a physical environment. The physical environment may include physical features such as a physical surface (e.g., floor, walls) or a physical object (e.g., table, lamp). In some examples, electronic device 101 may be configured to detect and/or capture images of the physical environment including table 106 (illustrated in the field of view of electronic device 101).

In some examples, as shown in FIG. 1, electronic device 101 includes one or more internal image sensors 114a oriented towards a face of the user (e.g., eye tracking cameras as described below with reference to FIGS. 2A-2B). In some examples, internal image sensors 114a are used for eye tracking (e.g., detecting a gaze of the user). Internal image sensors 114a are optionally arranged on the left and right portions of display 120 to enable eye tracking of the user’s left and right eyes. In some examples, electronic device 101 also includes external image sensors 114b and 114c facing outwards from the user to detect and/or capture the physical environment of the electronic device 101 and/or movements of the user’s hands or other body parts.

In some examples, display 120 has a field of view visible to the user. In some examples, the field of view visible to the user is the same as a field of view of external image sensors 114b and 114c. For example, when display 120 is optionally part of a head-mounted device, the field of view of display 120 is optionally the same as or similar to the field of view of the user’s eyes. In some examples, the field of view visible to the user is different from a field of view of external image sensors 114b and 114c (e.g., narrower than the field of view of external image sensors 114b and 114c). In other examples, the field of view of display 120 may be smaller than the field of view of the user’s eyes. A viewpoint of a user determines what content is visible in the field of view, a viewpoint generally specifies a location and a direction relative to the three-dimensional environment. As the viewpoint of a user shifts, the field of view of the three-dimensional environment will also shift accordingly. In some examples, electronic device 101 may be an optical see-through device in which display 120 is a transparent or translucent display through which portions of the physical environment may be directly viewed. In some examples, display 120 may be included within a transparent lens and may overlap all or a portion of the transparent lens. In other examples, electronic device may be a video-passthrough device in which display 120 is an opaque display configured to display images of the physical environment using images captured by external image sensors 114b and 114c. While a single display is shown in FIG. 1, it is understood that display 120 optionally includes more than one display. For example, display 120 optionally includes a stereo pair of displays (e.g., left and right display panels for the left and right eyes of the user, respectively) having displayed outputs that are merged (e.g., by the user’s brain) to create the view of the content shown in FIG. 1. In some examples, as discussed in more detail below with reference to FIGS. 2A-2B, the display 120 includes or corresponds to a transparent or translucent surface (e.g., a lens) that is not equipped with display capability (e.g., and is therefore unable to generate and display the virtual object 104) and alternatively presents a direct view of the physical environment in the user’s field of view (e.g., the field of view of the user’s eyes).

In some examples, the electronic device 101 is configured to display (e.g., in response to a trigger) a virtual object 104 in the three-dimensional environment. Virtual object 104 is represented by a cube illustrated in FIG. 1, which is not present in the physical environment, but is displayed in the three-dimensional environment positioned on the top of table 106 (e.g., real-world table or a representation thereof). Optionally, virtual object 104 is displayed as on the surface of the table 106 in the three-dimensional environment displayed via the display 120 of the electronic device 101 in response to detecting the planar surface of table 106 in the physical environment 100.

It is understood that virtual object 104 is a representative virtual object and one or more different virtual objects (e.g., of various dimensionality such as two-dimensional or other three-dimensional virtual objects) can be included and rendered in a three-dimensional environment. For example, the virtual object can represent an application or a user interface displayed in the three-dimensional environment. In some examples, the virtual object can represent content corresponding to the application and/or displayed via the user interface in the three-dimensional environment. In some examples, the virtual object 104 is optionally configured to be interactive and responsive to user input (e.g., air gestures, such as air pinch gestures, air tap gestures, and/or air touch gestures), such that a user may virtually touch, tap, move, rotate, or otherwise interact with, the virtual object 104.

As discussed herein, one or more air pinch gestures performed by a user (e.g., with hand 103 in FIG. 1) are detected by one or more input devices of electronic device 101 and interpreted as one or more user inputs directed to content displayed by electronic device 101. Additionally or alternatively, in some examples, the one or more user inputs interpreted by the electronic device 101 as being directed to content displayed by electronic device 101 (e.g., the virtual object 104) are detected via one or more hardware input devices (e.g., controllers, touch pads, proximity sensors, buttons, sliders, knobs) rather than via the one or more input devices that are configured to detect air gestures, such as the one or more air pinch gestures, performed by the user. Such depiction is intended to be exemplary rather than limiting; the user optionally provides user inputs using different air gestures and/or using other forms of input.

In some examples, the electronic device 101 may be configured to communicate with a second electronic device, such as a companion device. For example, as illustrated in FIG. 1, the electronic device 101 is optionally in communication with electronic device 160. In some examples, electronic device 160 corresponds to a mobile electronic device, such as a smartphone, a tablet computer, a smart watch, a laptop computer, or other electronic device. In some examples, electronic device 160 corresponds to a non-mobile electronic device, which is generally stationary and not easily moved within the physical environment (e.g., desktop computer, server). Additional examples of electronic device 160 are described below with reference to the architecture block diagram of FIG. 2B. In some examples, the electronic device 101 and the electronic device 160 are associated with a same user. For example, in FIG. 1, the electronic device 101 may be positioned on (e.g., mounted to) a head of a user and the electronic device 160 may be positioned near electronic device 101, such as in a hand 103 of the user (e.g., the hand 103 is holding the electronic device 160), a pocket or bag of the user, or a surface near the user. The electronic device 101 and the electronic device 160 are optionally associated with a same user account of the user (e.g., the user is logged into the user account on the electronic device 101 and the electronic device 160). Additional details regarding the communication between the electronic device 101 and the electronic device 160 are provided below with reference to FIGS. 2A-2B.

In some examples, displaying an object in a three-dimensional environment is caused by or enables interaction with one or more user interface objects in the three-dimensional environment. For example, initiation of display of the object in the three-dimensional environment can include interaction with one or more virtual options/affordances displayed in the three-dimensional environment. In some examples, a user’s gaze may be tracked by the electronic device as an input for identifying one or more virtual options/affordances targeted for selection when initiating display of an object in the three-dimensional environment. For example, gaze can be used to identify one or more virtual options/affordances targeted for selection using another selection input. In some examples, a virtual option/affordance may be selected using hand-tracking input detected via an input device in communication with the electronic device. In some examples, objects displayed in the three-dimensional environment may be moved and/or reoriented in the three-dimensional environment in accordance with movement input detected via the input device.

In the descriptions that follows, an electronic device that is in communication with one or more displays and one or more input devices is described. It is understood that the electronic device optionally is in communication with one or more other physical user-interface devices, such as a touch-sensitive surface, a physical keyboard, a mouse, a joystick, a hand tracking device, an eye tracking device, a stylus, or the like. Further, as described above, it is understood that the described electronic device, display and touch-sensitive surface are optionally distributed between two or more devices. Therefore, as used in this disclosure, information displayed as on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device, or touch input received on the surface of a stylus) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

In some examples, a three-dimensional object is displayed in a computer-generated three-dimensional environment with a particular orientation that controls one or more behaviors of the three-dimensional object (e.g., when the three-dimensional object is moved within the three-dimensional environment). In some examples, the orientation in which the three-dimensional object is displayed in the three-dimensional environment is selected by a user of the electronic device or automatically selected by the electronic device. For example, when initiating presentation of the three-dimensional object in the three-dimensional environment, the user may select a particular orientation for the three-dimensional object or the electronic device may automatically select the orientation for the three-dimensional object (e.g., based on a type of the three-dimensional object).

In some examples, a three-dimensional object can be displayed in the three-dimensional environment in a world-locked orientation, a body-locked orientation, a tilt-locked orientation, or a head-locked orientation, as described below. As used herein, an object that is displayed in a body-locked orientation in a three-dimensional environment has a distance and orientation offset relative to a portion of the user’s body (e.g., the user’s torso). Alternatively, in some examples, a body-locked object has a fixed distance from the user without the orientation of the content being referenced to any portion of the user’s body (e.g., may be displayed in the same cardinal direction relative to the user, regardless of head and/or body movement). Additionally or alternatively, in some examples, the body-locked object may be configured to always remain gravity or horizon (e.g., normal to gravity) aligned, such that head and/or body changes in the roll direction would not cause the body-locked object to move within the three-dimensional environment. Rather, translational movement in either configuration would cause the body-locked object to be repositioned within the three-dimensional environment to maintain the distance offset.

As used herein, an object that is displayed in a head-locked orientation in a three-dimensional environment has a distance and orientation offset relative to the user’s head. In some examples, a head-locked object moves within the three-dimensional environment as the user’s head moves (as a viewpoint of the user changes).

As used herein, an object that is displayed in a world-locked orientation in a three-dimensional environment does not have a distance or orientation offset relative to the user.

As used herein, an object that is displayed in a tilt-locked orientation in a three-dimensional environment (referred to herein as a tilt-locked object) has a distance offset relative to the user, such as a portion of the user’s body (e.g., the user’s torso) or the user’s head. In some examples, a tilt-locked object is displayed at a fixed orientation relative to the three-dimensional environment. In some examples, a tilt-locked object moves according to a polar (e.g., spherical) coordinate system centered at a pole through the user (e.g., the user’s head). For example, the tilt-locked object is moved in the three-dimensional environment based on movement of the user’s head within a spherical space surrounding (e.g., centered at) the user’s head. Accordingly, if the user tilts their head (e.g., upward or downward in the pitch direction) relative to gravity, the tilt-locked object would follow the head tilt and move radially along a sphere, such that the tilt-locked object is repositioned within the three-dimensional environment to be the same distance offset relative to the user as before the head tilt while optionally maintaining the same orientation relative to the three-dimensional environment. In some examples, if the user moves their head in the roll direction (e.g., clockwise or counterclockwise) relative to gravity, the tilt-locked object is not repositioned within the three-dimensional environment.

FIGS. 2A-2B illustrate block diagrams of example architectures for electronic devices according to some examples of the disclosure. In some examples, electronic device 201 and/or electronic device 260 include one or more electronic devices. For example, the electronic device 201 may be a portable device, an auxiliary device in communication with another device, a head-mounted display, or a head-worn speaker, respectively. In some examples, electronic device 201 corresponds to electronic device 101 described above with reference to FIG. 1. In some examples, electronic device 260 corresponds to electronic device 160 described above with reference to FIG. 1.

As illustrated in FIG. 2A, the electronic device 201 optionally includes one or more sensors, such as one or more hand tracking sensors 202, one or more location sensors 204A, one or more image sensors 206A (optionally corresponding to internal image sensors 114a and/or external image sensors 114b and 114c in FIG. 1), one or more touch-sensitive surfaces 209A, one or more motion and/or orientation sensors 210A, one or more eye tracking sensors 212, one or more microphones 213A or other audio sensors, one or more body tracking sensors (e.g., torso and/or head tracking sensors). The electronic device 201 optionally includes one or more output devices, such as one or more display generation components 214A, optionally corresponding to display 120 in FIG. 1, one or more speakers 216A, or one or more haptic output devices (not shown). The electronic device 201 optionally includes one or more processors 218A, one or more memories 220A, and/or communication circuitry 222A. One or more communication buses 208A are optionally used for communication between the above-mentioned components of electronic device 201.

Additionally, the electronic device 260 optionally includes the same or similar components as the electronic device 201. For example, as shown in FIG. 2B, the electronic device 260 optionally includes one or more location sensors 204B, one or more image sensors 206B, one or more touch-sensitive surfaces 209B, one or more orientation sensors 210B, one or more microphones 213B, one or more display generation components 214B, one or more speakers 216B, one or more processors 218B, one or more memories 220B, and/or communication circuitry 222B. One or more communication buses 208B are optionally used for communication between the above-mentioned components of electronic device 260.

The electronic devices 201 and 260 are optionally configured to communicate via a wired or wireless connection (e.g., via communication circuitry 222A, 222B) between the two electronic devices. For example, as indicated in FIG. 2A, the electronic device 260 may function as a companion device to the electronic device 201. For example, in some examples, the electronic device 260 processes sensor inputs from electronic devices 201 and 260 and/or generates content for display using display generation components 214A of electronic device 201.

Communication circuitry 222A, 222B optionally includes circuitry for communicating with electronic devices, networks, such as the Internet, intranets, a wired network and/or a wireless network, cellular networks, and wireless local area networks (LANs). Communication circuitry 222A, 222B optionally includes circuitry for communicating using near-field communication (NFC) and/or short-range communication, such as Bluetooth®. In some examples, communication circuitry 222A, 222B includes or supports Wi-Fi (e.g., an 802.11 protocol), Ethernet, ultra-wideband ("UWB"), high frequency systems (e.g., 900 MHz, 2.4 GHz, and 5.6 GHz communication systems), or any other communications protocol, or any combination thereof.

One or more processors 218A, 218B include one or more general processors, one or more graphics processors, and/or one or more digital signal processors. In some examples, one or more processors 218A, 218B include one or more microprocessors, one or more central processing units, one or more application-specific integrated circuits, one or more field-programmable gate arrays, one or more programmable logic devices, or a combination of such devices. In some examples, memories 220A and/or 220B are a non-transitory computer-readable storage medium (e.g., flash memory, random access memory, or other volatile or non-volatile memory or storage) that stores computer-readable instructions configured to be executed by the one or more processors 218A, 218B to perform the techniques, processes, and/or methods described herein. In some examples, memories 220A and/or 220B can include more than one non-transitory computer-readable storage medium. A non-transitory computer-readable storage medium can be any medium (e.g., excluding a signal) that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on compact disc (CD), digital versatile disc (DVD), or Blu-ray technologies, as well as persistent solid-state memory such as flash, solid-state drives, and the like.

In some examples, one or more display generation components 214A, 214B include a single display (e.g., a liquid-crystal display (LCD), organic light-emitting diode (OLED), or other types of display). In some examples, the one or more display generation components 214A, 214B include multiple displays. In some examples, the one or more display generation components 214A, 214B can include a display with touch capability (e.g., a touch screen), a projector, a holographic projector, a retinal projector, a transparent or translucent display, or the like. In some examples, the electronic device does not include one or more display generation components 214A or 214B. For example, instead of the one or more display generation components 214A or 214B, some electronic devices include transparent or translucent lenses or other surfaces that are not configured to display or present virtual content. However, it should be understood that, in such instances, the electronic device 201 and/or the electronic device 260 are optionally equipped with one or more of the other components illustrated in FIGS. 2A and 2B and described herein, such as the one or more hand tracking sensors 202, one or more eye tracking sensors 212, one or more image sensors 206A, and/or the one or more motion and/or orientations sensors 210A. Alternatively, in some examples, the one or more display generation components 214A or 214B are provided separately from the electronic devices 201 and/or 260. For example, the one or more display generation components 214A, 214B are in communication with the electronic device 201 (and/or electronic device 260), but are not integrated with the electronic device 201 and/or electronic device 260 (e.g., within a housing of the electronic devices 201, 260). In some examples, electronic devices 201 and 260 include one or more touch-sensitive surfaces 209A and 209B, respectively, for receiving user inputs, such as tap inputs and swipe inputs or other gestures (e.g., hand-based or finger-based gestures). In some examples, the one or more display generation components 214A, 214B and the one or more touch-sensitive surfaces 209A, 209B form one or more touch-sensitive displays (e.g., a touch screen integrated with each of electronic devices 201 and 260 or external to each of electronic devices 201 and 260 that is in communication with each of electronic devices 201 and 260).

Electronic devices 201 and 260 optionally include one or more image sensors 206A and 206B, respectively. The one or more image sensors 206A, 206B optionally include one or more visible light image sensors, such as charged coupled device (CCD) sensors, and/or complementary metal-oxide-semiconductor (CMOS) sensors operable to obtain images of physical objects from the real-world environment. The one or more image sensors 206A, 206B also optionally include one or more infrared (IR) sensors, such as a passive or an active IR sensor, for detecting infrared light from the real-world environment. For example, an active IR sensor includes an IR emitter for emitting infrared light into the real-world environment. The one or more image sensors 206A, 206B also optionally include one or more cameras configured to capture movement of physical objects in the real-world environment. The one or more image sensors 206A, 206B also optionally include one or more depth sensors configured to detect the distance of physical objects from electronic device 201 and/or 260. In some examples, information from one or more depth sensors can allow the device to identify and differentiate objects in the real-world environment from other objects in the real-world environment. In some examples, one or more depth sensors can allow the device to determine the texture and/or topography of objects in the real-world environment. In some examples, the one or more image sensors 206A or 206B are included in an electronic device different from the electronic devices 201 and/or 260. For example, the one or more image sensors 206A, 206B are in communication with the electronic device 201, 260, but are not integrated with the electronic device 201, 260 (e.g., within a housing of the electronic device 201, 260). Particularly, in some examples, the one or more cameras of the one or more image sensors 206A, 206B are integrated with and/or coupled to one or more separate devices from the electronic devices 201 and/or 260 (e.g., but are in communication with the electronic devices 201 and/or 260), such as one or more input and/or output devices (e.g., one or more speakers and/or one or more microphones, such as earphones or headphones) that include the one or more image sensors 206A, 206B. In some examples, electronic device 201 or electronic device 260 corresponds to a head-worn speaker (e.g., headphones or earbuds). In such instances, the electronic device 201 or the electronic device 260 is equipped with a subset of the other components illustrated in FIGS. 2A and 2B and described herein. In some such examples, the electronic device 201 or the electronic device 260 is equipped with one or more image sensors 206A, 206B, the one or more motion and/or orientations sensors 210A, 210B, and/or speakers 216A, 216B.

In some examples, electronic device 201, 260 uses CCD sensors, event cameras, and depth sensors in combination to detect the physical environment around electronic device 201, 260. In some examples, the one or more image sensors 206A, 206B include a first image sensor and a second image sensor. The first image sensor and the second image sensor work in tandem and are optionally configured to capture different information of physical objects in the real-world environment. In some examples, the first image sensor is a visible light image sensor, and the second image sensor is a depth sensor. In some examples, electronic device 201, 260 uses the one or more image sensors 206A, 206B to detect the position and orientation of electronic device 201, 260 and/or the one or more display generation components 214A, 214B in the real-world environment. For example, electronic device 201, 260 uses the one or more image sensors 206A, 206B to track the position and orientation of the one or more display generation components 214A, 214B relative to one or more fixed objects in the real-world environment.

In some examples, electronic devices 201 and 260 include one or more microphones 213A and 213B, respectively, or other audio sensors. Electronic device 201, 260 optionally uses the one or more microphones 213A, 213B to detect sound from the user and/or the real-world environment of the user. In some examples, the one or more microphones 213A, 213B include an array of microphones (e.g., a plurality of microphones) that optionally operate in tandem, such as to identify ambient noise or to locate the source of sound in space of the real-world environment.

Electronic devices 201 and 260 include one or more location sensors 204A and 204B, respectively, for detecting a location of electronic device 201 and/or the one or more display generation components 214A and a location of electronic device 260 and/or the one or more display generation components 214B, respectively. For example, the one or more location sensors 204A, 204B can include a global positioning system (GPS) receiver that receives data from one or more satellites and allows electronic device 201, 260 to determine the absolute position of the electronic device in the physical world.

Electronic devices 201 and 260 include one or more orientation sensors 210A and 210B, respectively, for detecting orientation and/or movement of electronic device 201 and/or the one or more display generation components 214A and orientation and/or movement of electronic device 260 and/or the one or more display generation components 214B, respectively. For example, electronic device 201, 260 uses the one or more orientation sensors 210A, 210B to track changes in the position and/or orientation of electronic device 201, 260 and/or the one or more display generation components 214A, 214B, such as with respect to physical objects in the real-world environment. The one or more orientation sensors 210A, 210B optionally include one or more gyroscopes and/or one or more accelerometers.

Electronic device 201 includes one or more hand tracking sensors 202 and/or one or more eye tracking sensors 212, in some examples. It is understood, that although referred to as hand tracking or eye tracking sensors, that electronic device 201 additionally or alternatively optionally includes one or more other body tracking sensors, such as one or more leg, one or more torso and/or one or more head tracking sensors. The one or more hand tracking sensors 202 are configured to track the position and/or location of one or more portions of the user’s hands, and/or motions of one or more portions of the user’s hands with respect to the three-dimensional environment, relative to the one or more display generation components 214A, and/or relative to another defined coordinate system. The one or more eye tracking sensors 212 are configured to track the position and movement of a user’s gaze (e.g., a user’s attention, including eyes, face, or head, more generally) with respect to the real-world or three-dimensional environment and/or relative to the one or more display generation components 214A. In some examples, the one or more hand tracking sensors 202 and/or the one or more eye tracking sensors 212 are implemented together with the one or more display generation components 214A. In some examples, the one or more hand tracking sensors 202 and/or the one or more eye tracking sensors 212 are implemented separate from the one or more display generation components 214A. In some examples, electronic device 201 alternatively does not include the one or more hand tracking sensors 202 and/or the one or more eye tracking sensors 212. In some such examples, the one or more display generation components 214A may be utilized by the electronic device 260 to provide a three-dimensional environment and the electronic device 260 may utilize input and other data gathered via the other one or more sensors (e.g., the one or more location sensors 204A, the one or more image sensors 206A, the one or more touch-sensitive surfaces 209A, the one or more motion and/or orientation sensors 210A, and/or the one or more microphones 213A or other audio sensors) of the electronic device 201 as input and data that is processed by the one or more processors 218B of the electronic device 260. Additionally or alternatively, electronic device 260 optionally does not include other components shown in FIG. 2B, such as the one or more location sensors 204B, the one or more image sensors 206B, or the one or more touch-sensitive surfaces 209B. In some such examples, the one or more display generation components 214A may be utilized by the electronic device 260 to provide a three-dimensional environment and the electronic device 260 may utilize input and other data gathered via the one or more motion and/or orientation sensors 210A (and/or the one or more microphones 213A) of the electronic device 201 as input.

In some examples, the one or more hand tracking sensors 202 (and/or other body tracking sensors, such as leg, torso and/or head tracking sensors) can use the one or more image sensors 206 (e.g., one or more IR cameras, 3D cameras, depth cameras) that capture three-dimensional information from the real-world including one or more body parts (e.g., hands, legs, or torso of a human user). In some examples, the hands can be resolved with sufficient resolution to distinguish fingers and their respective positions. In some examples, the one or more image sensors 206A are positioned relative to the user to define a field of view of the one or more image sensors 206A and an interaction space in which finger/hand position, orientation and/or movement captured by the image sensors are used as inputs (e.g., to distinguish from a user’s resting hand or other hands of other persons in the real-world environment). Tracking the fingers/hands for input (e.g., gestures, touch, tap) can be advantageous in that it does not require the user to touch, hold or wear any sort of beacon, sensor, or other marker.

In some examples, the one or more eye tracking sensors 212 include at least one eye tracking camera (e.g., IR cameras) and/or illumination sources (e.g., IR light sources, such as LEDs) that emit light towards a user’s eyes. The eye tracking cameras may be pointed towards a user’s eyes to receive reflected IR light from the light sources directly or indirectly from the eyes. In some examples, both eyes are tracked separately by respective eye tracking cameras and illumination sources, and a focus/gaze can be determined from tracking both eyes. In some examples, one eye (e.g., a dominant eye) is tracked by one or more respective eye tracking cameras/illumination sources.

Electronic devices 201 and 260 are not limited to the components and configuration of FIGS. 2A-2B, but can include fewer, other, or additional components in multiple configurations. In some examples, electronic device 201 and/or electronic device 260 can each be implemented between multiple electronic devices (e.g., as a system). In some such examples, each of (or more of) the electronic devices may include one or more of the same components discussed above, such as various sensors, one or more display generation components, one or more speakers, one or more processors, one or more memories, and/or communication circuitry. A person or persons using electronic device 201 and/or electronic device 260, is optionally referred to herein as a user or users of the device.

Attention is now directed towards interactions with one or more virtual objects, such as virtual content windows, that are displayed in a three-dimensional environment presented at an electronic device (e.g., corresponding to electronic device 201). The electronic device 201 transitions between various operation modes that control how the virtual content window moves in accordance with a user of the electronic device moving through the three-dimensional/physical environment.

In some examples, electronic devices display virtual content within a three-dimensional environment, such as a virtual reality (VR) or XR environment. The virtual content can be displayed in a window in the three-dimensional environment that follows the movement of a user wearing the electronic device within the three-dimensional environment. For example, the user walks in a trajectory while wearing the electronic device. In some examples, movement of the user occurs in directions other than the trajectory, such as the swinging of the arm of the user, head moving, torso turning, or similar movements, that will cause undesired movement or jittering of the virtual content window if the electronic device 101 moves the virtual content window in accordance with these movements. To reduce jittering and/or shaking of the virtual content window, in some examples, electronic device 101 operates in a default, fixed orientation mode in which the virtual content 302 moves in accordance with translation of the user, but not rotation of the user. To maintain visibility of the virtual content 302 as the user changes the angle of their trajectory, the electronic device 101 transitions to orientation mode(s) that include moving the virtual content 302 in response to rotation and translation of the user when one or more criteria are satisfied. Requiring criteria to be satisfied to transition from the orientation locked mode optionally causes the electronic device 101 to selectively update or not update the position of the virtual content 302 in accordance with rotation of the user. Transitioning between orientation modes depends on the tracking of the trajectory of the user, a direction of a body part (e.g., torso) of a user, and an angle therebetween, for example. As described herein, in some examples, an electronic device transitions the display of the virtual content window from a first orientation mode (e.g., default mode) to a different orientation mode (e.g., second orientation mode or third orientation mode) depending on whether the trajectory vector (e.g., first vector) of the user and/or an orientation vector (e.g., second vector) of the user meet respective criteria required to transition between the respective orientation modes.

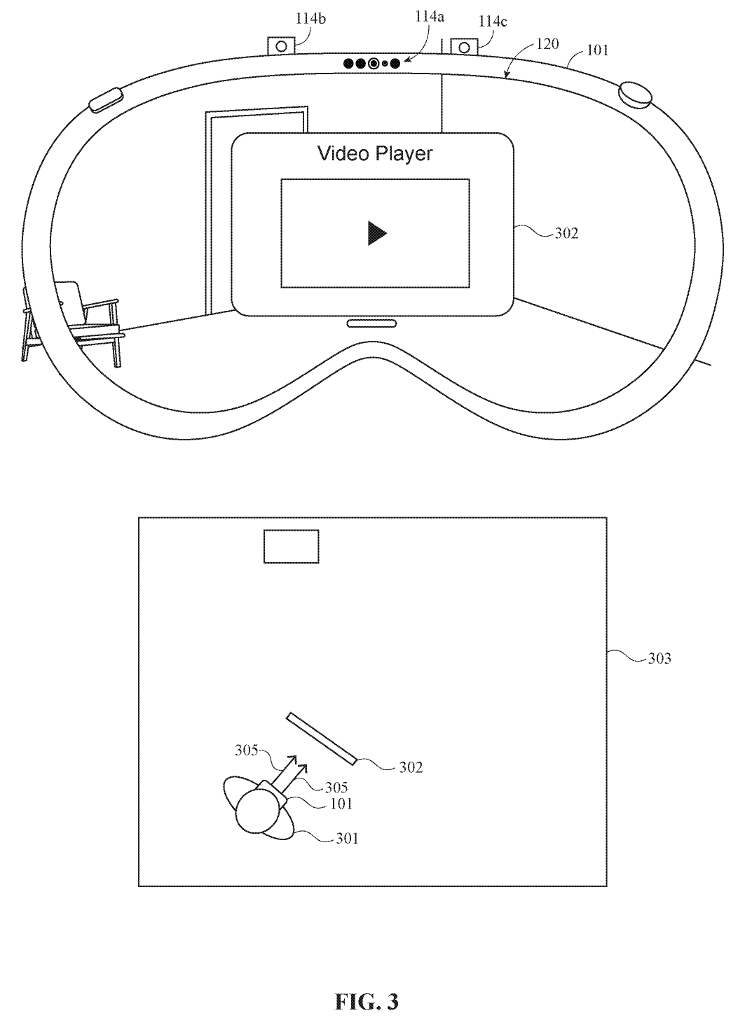

FIG. 3 illustrates an exemplary three-dimensional environment displayed using one or more displays of an electronic device according to examples of the disclosure. In some examples, electronic device 101 is a wearable device (e.g., such as a head-mounted device) that is worn by a user 301. In some examples, and as illustrated in FIG. 3, electronic device 101 includes display 120 that displays virtual content 302 in a three-dimensional environment 303. It is understood that the location of virtual content 302 is a non-limiting presentation of the location of the virtual content and that the virtual content can be displayed at one or more different locations within the display of the three-dimensional environment.

In some examples, the methods described herein are performed at an electronic device 101. Optionally, electronic device 101 can correspond to electronic device 201 or another device described herein that can display virtual content to a user. In some examples, electronic device 101 is a head-mounted device. In some examples, electronic device 101 is in communication with one or more displays. The one or more displays can be any display described herein. In some examples, electronic device 101 is in communication with one or more input devices. The one or more input devices can be any of the devices described herein configured to receive inputs including those from the user 301 or from sensing the three-dimensional environment 303. In some examples, electronic device 101 displays virtual content 302 via the one or more displays. In some examples, electronic device 101 displays the virtual content 302 via the display 120 in the three-dimensional environment 303 in a variety of orientation modes that include respective movement patterns of virtual content 302 based on movement of the user in three-dimensional environment 303 and/or of the electronic device 101.

FIG. 3 also depicts a bird-eye view (e.g., top-down view) of a three-dimensional environment 303. In some examples, the three-dimensional environment 303 remains in place, and is visible around the virtual content 302 in the three-dimensional environment 303. For example, the three-dimensional environment 303 can be a virtual room. In some examples, three-dimensional environment 303 includes the real-world three-dimensional environment of the user 301 and/or electronic device 101, and the cameras and sensors of electronic device 101 are used to capture and display representations of the real-world environment and/or present the real-world environment in real-time (e.g., passthrough video actively displaying the real environment). In some other examples, three-dimensional environment 303 is a true, transparent view of the real environment viewable through a transparent portion of the display (e.g., presenting a view of the real environment through a transparent lens on electronic device 101). While displaying virtual content 302 in three-dimensional environment 303, the user can interact with the virtual content 302. As shown in FIG. 3, for example, the three-dimensional environment 303 is a room.

In some examples, electronic device 101 displays, via the one or displays, virtual content 302 in a three-dimensional environment 303. In some examples, virtual content 302 is a user interface of an application that is displayed in the three-dimensional environment 303 in a separate window and/or screen (e.g., virtual content window). For example, the virtual content 302 can be a video application, game application, movie application, or any other suitable application, including media applications, in which content is displayed. In some examples, the electronic device 101 updates the position of virtual content 302 so that the virtual content 302 appears to follow user 301 as the viewpoint on display 120 changes (e.g., as the user moves). For example, in FIG. 3, virtual content 302 is a video player content.

In some examples, the user uses the electronic device 101 while wearing the electronic device 101 or a portion thereof (e.g., the electronic device 101 is or includes a head-mounted display). Optionally, the user moves, such as by walking, while wearing the electronic device 101. In some examples, electronic device 101 tracks a first vector indicative of a trajectory of movement of the electronic device 101 determined using the one or more input devices, described herein as trajectory vector 305. In some examples, the trajectory of the electronic device 101 corresponds to the trajectory movement of the user 301, such as the direction in which the user walks. A trajectory of movement can be defined as the current and/or predicted path of movement of the user within the three-dimensional environment 303, and/or a directional path the user moves in while wearing electronic device 101. In some examples, an angle of trajectory vector 305 is based on rotation in the yaw direction only (e.g., vertical axis) and is not based on rotation in any other planar direction. In some examples, the angle of trajectory vector 305 is based on rotation in multiple directions. In some examples, as shown in FIG. 3, an angle of the trajectory vector 305 may be defined relative to a center of the viewpoint of the user 301 in the three-dimensional environment 303, such as a center of display 120. In some examples, the trajectory vector 305 depends on the direction user 301 moves, and/or a direction a portion (e.g., torso, head, or face) of the user 301 or of the electronic device 101 is facing when not moving translationally in the three-dimensional environment 303. Translational movement of the user 301 in three-dimensional environment 303 can be defined as the type of planar motion of the user in the environment independent from the orientation (e.g., including rotation) of the user in the environment.

In some examples, electronic device 101 can track the trajectory vector 305 using one or more input devices, such as a camera or another input device mentioned herein. In some examples, the camera or another input device captures a motion path of user 301 and, based on the captured motion path, predicts what direction user 301 may be moving in next. In some examples, the camera or other input device detects a change in the translational movement of the user (e.g., user turning or changing their overall direction) by detecting a predicted trajectory of electronic device 101. In some examples, the predicted trajectory of the electronic device 101 corresponds to a prediction of a direction in which user 301 will move next (e.g., within a threshold amount of time of the current time, such as 0.05, 0.15, 0.25, 0.5, 1, 2, or 5 seconds in the future). For example, to track the predicted motion, the electronic device detects previous position frames of user 301 moving relative to the three-dimensional environment 300 (e.g., the previous trajectory of the user), and then extrapolates and applies these detections to the current frame of motion of the electronic device 101 (e.g., a current trajectory of the user).

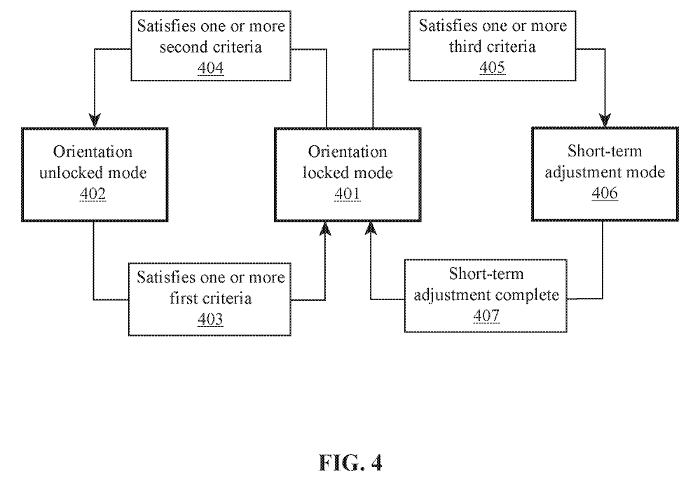

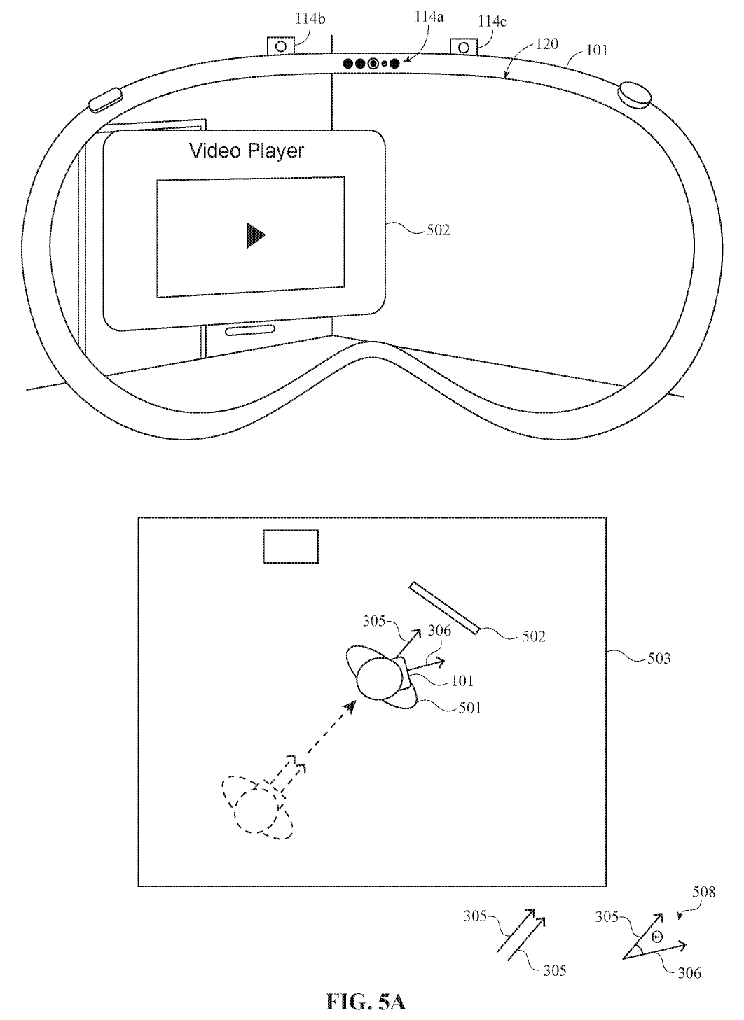

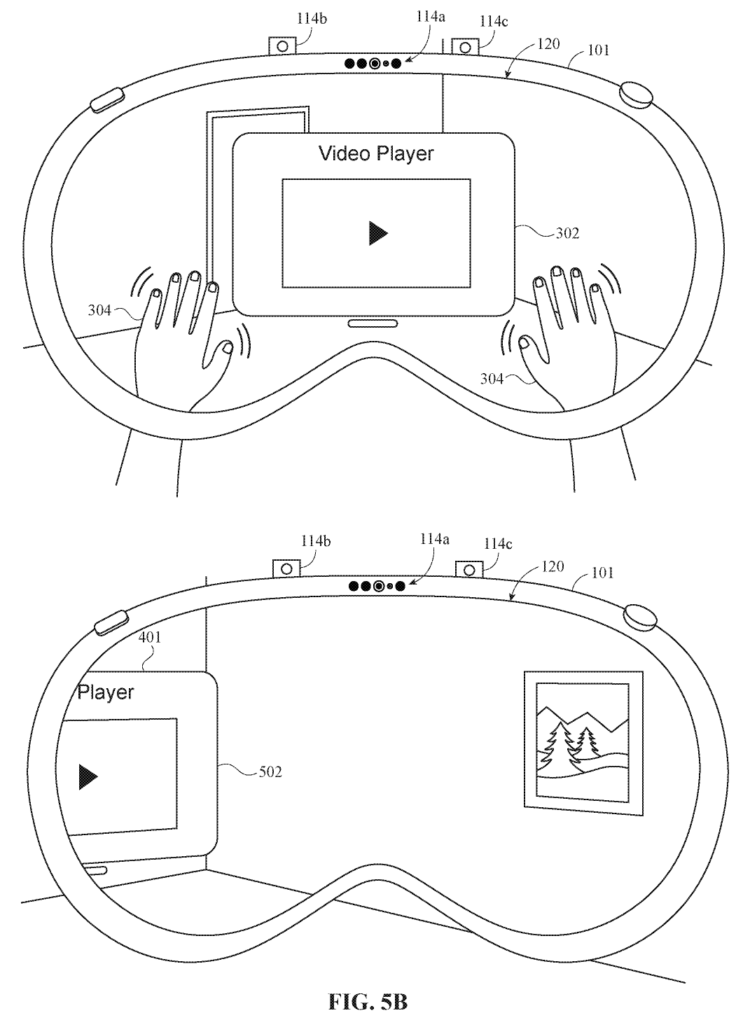

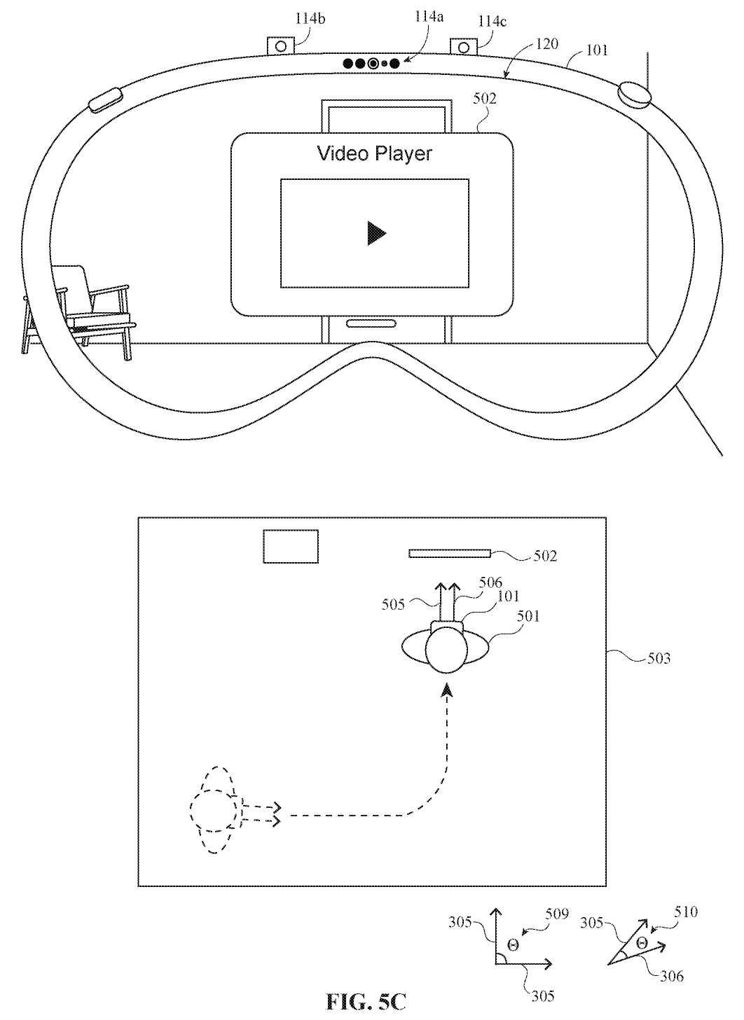

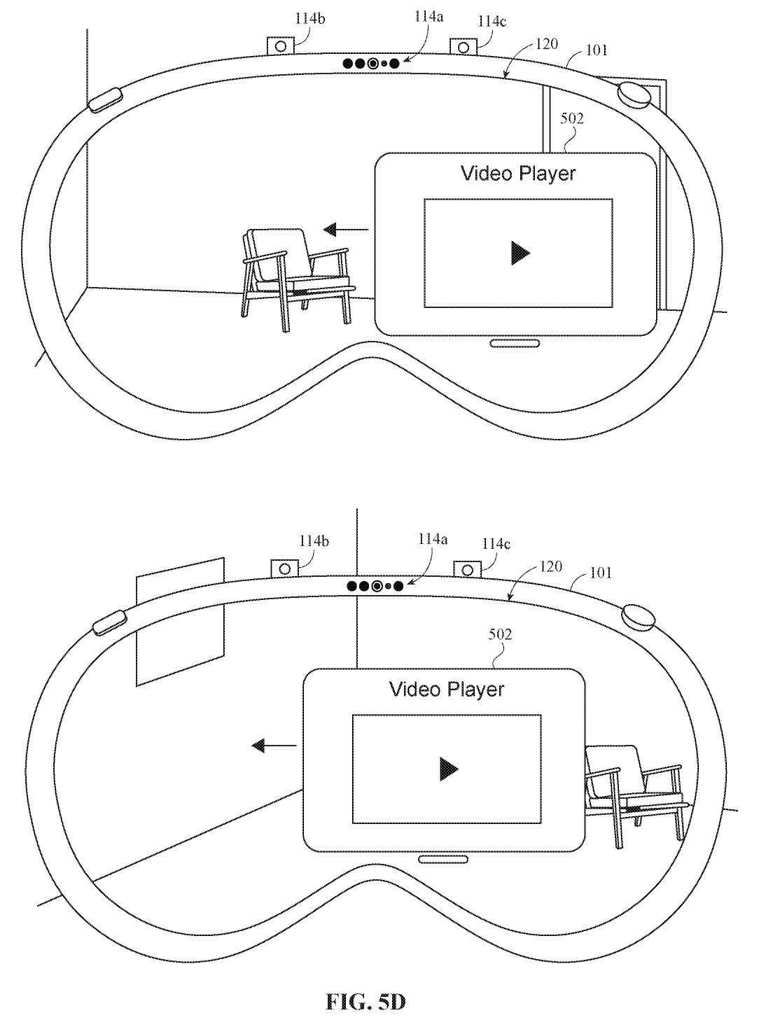

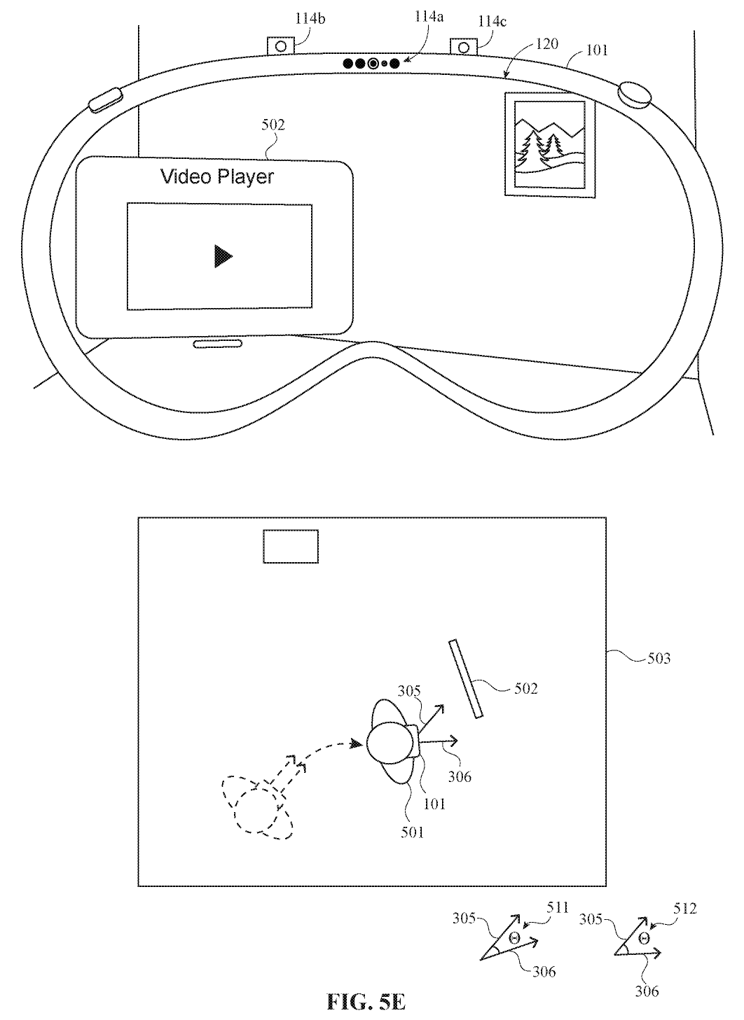

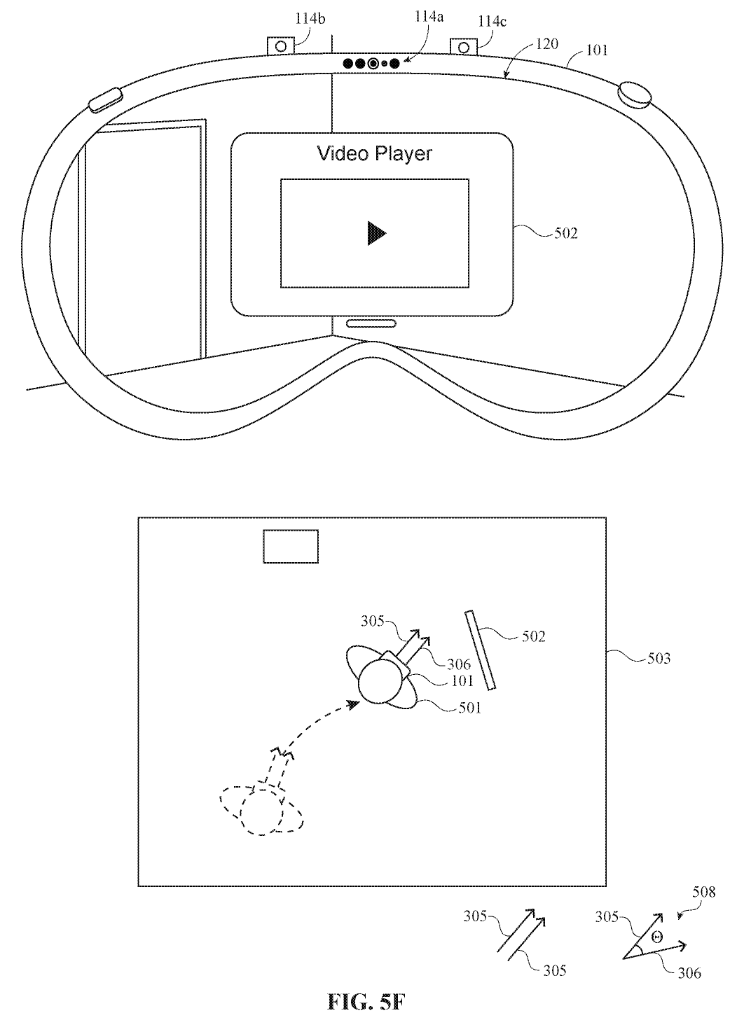

In some examples, electronic device 101 uses trajectory vector 305 to detect when user 301 is moving around a turn, or has moved around a turn relative to the trajectory of the user when the electronic device 101 initiated the orientation locked mode. For example, when an angle between the trajectory vector 305 of a current frame of motion and the trajectory vector 305 when the electronic device 101 entered the orientation locked mode exceeds a first predefined threshold angle, then electronic device 101 detects that user 301 is going around a turn or has turned within three-dimensional environment 303. As another example, when an angle between the trajectory vector 305 of respective frames of motion and a trajectory vector 305 when the electronic device 101 entered the orientation locked mode exceeds a second predefined threshold for a predetermined time, then the electronic device 101 detects that the user is going around a turn or has turned within three-dimensional environment 303. In some examples, the first predefined threshold angle is greater than the second predefined threshold angle as described below. In some examples, if the angle between compared trajectory vectors 305 is less than the first threshold angle, less than the second threshold angle, and/or exceeds the second threshold angle for less than the predetermined time, then the electronic device 101 determines the user has not gone around a turn. In some examples, the electronic device 101 detects continuation of a turn by comparing the current trajectory vector 305 to a previous trajectory vector 305 that was measured a predetermined time ago. For example, if the angle between the compared trajectory vectors is less than a third threshold angle, the electronic device 101 determines that the user has completed the turn and is no longer turning. For example, if the angle between the compared trajectory vectors is less than 15 degrees over the past 1 second, then the electronic device 101 detects that user 301 is no longer turning. Evaluation of the trajectory vector for the purpose of selectively transitioning between orientation modes is described in further detail below with respect to FIGS. 4-5F.

In some examples, electronic device 101 tracks a second vector indicative of an orientation of the user using the one or more input devices on electronic device 101, described herein as orientation vector 306. An orientation of the user can be defined as a frame of reference of a body part of the user, based on the orientation of the electronic device worn by the user, or some other object to determine which direction in the environment is “front” relative to the user (e.g., rotation detected unrelated to the trajectory of the user). In some examples, as indicated in FIG. 3, the orientation vector 306 may be defined as extending away from a center of the viewpoint of the electronic device 101, such as a center of the display 120. In some examples, orientation vector 306 is defined as extending from the center of the head and/or torso of user 301 when the user 301 is wearing the electronic device 101. In some examples, orientation vector 306 is independent of a direction of a gaze of the user 301 (e.g., a direction in which the user 301 is looking). In some examples, electronic device 101 tracks orientation vector 306 in the yaw direction only and does not track user orientation in any other planar direction. In some examples, the electronic device 101 tracks the orientation vector 306 in a plurality of directions. In some examples, electronic device 101 can track the orientation vector 306 using one or more input devices, such as a camera or any other input device mentioned herein. For example, the camera or other input device detects a change or movement of the orientation vector 306 by detecting a movement of viewpoint of the user 301 in display 120. For example, the movement of the three-dimensional environment 303 detected by the camera or input device indicates that user 301 has rotated either their head and/or torso, optionally while moving according to trajectory vector 305. In some examples, the orientation vector 306 points in a first direction in the three-dimensional environment 303 relative to the electronic device 101, while the trajectory of the user (e.g., trajectory vector 305) points in a different direction. For example, as shown in FIG. 3, when the electronic device 101 is a head-mounted device, orientation vector 306 points in the same direction as the head and torso of user 301, though the user may move in a different direction than the direction in which their head faces.

In some examples, electronic device 101 displays virtual content 302 in various orientation modes according to evaluation of the trajectory vector 305 and the orientation vector 306 against one or more criteria described below. In some examples, the window displaying virtual content 302 “follows” the translation of the user and/or the rotation of the user in the three-dimensional environment 303. For example, if the user 301 walks in a straight line, the electronic device 101 moves the virtual content 302 in a first position in accordance with translation of the user 301, so the user 301 does not move away from the virtual content 302. As another example, if the user 301 turns their trajectory relative to the trajectory of the user when the electronic device 101 initiated the orientation locked mode while walking along a corner, the electronic device 101 moves the virtual content 302 in a second position in accordance with the translation and rotation of the user 301 so that the user 301 does not move away or turn away from the virtual content 302. However, were the electronic device 101 to move the virtual content 302 in accordance with all rotational movements of the user, the virtual content 302 would appear to jitter or move in other distracting ways. For example, if a user turns their orientation (e.g., head and/or torso) to the side while walking forward to avoid and/or sidestep an object in the path of their trajectory in the three-dimensional environment 303, electronic device 101 forgoes moving the virtual content 302 based on the rotation of the user. To allow the virtual content to stay in view of the user while the user moves and rotates around the environment without the distractions of jittering, electronic device 101 transitions the display of the virtual content 302 between various default and corrective orientation modes described herein.

FIG. 4 illustrates a flow chart of a method for transitioning between the orientation modes the electronic device 101 uses to display virtual content 302 while the user is moving in accordance with some examples of the disclosure. Electronic device 101 can transition the display of virtual content 302 between a first, default orientation mode (e.g., orientation locked mode 401), a second orientation mode (e.g., orientation unlocked mode 402), and a third orientation mode (e.g., short-term adjustment mode 406), with respective orientation modes having respective sets of one or more conditions (e.g., one or more first criteria 403, one or more second criteria 404, and/or one or more third criteria 405) that need to be satisfied in order for the electronic device 101 to transition into that respective mode. In some examples, electronic device 101 moves the location of virtual content 502 in a first position while operating in orientation locked mode 401, in a second position while operating in orientation unlocked mode 402, and in a third position while operating in short-term adjustment mode 406.

In some examples, electronic device 101 displays virtual content 302 in an orientation locked mode 401 within in a three-dimensional environment 303 while the user moves in the three-dimensional environment 303. In some examples, the orientation locked mode 401 is a default orientation mode of the electronic device 101 while the electronic device 101 and/or the user are moving. In some examples, the electronic device 101 moves virtual content 302 in a first position while operating in orientation locked mode 401. Additionally or alternatively, the electronic device 101 transitions to the orientation locked mode 401 from the orientation unlocked mode 402 or the short-term adjustment mode 406 as described below.

In some examples, the orientation locked mode 401 includes moving the virtual content 302 in the three-dimensional environment 303 in a first position in accordance with translational movement of a user 301 without moving the virtual content 302 in accordance with rotational movement of the user. Thus, for example, operating in the orientation locked mode 401 reduces jittering and/or distracting movement of the virtual content 302 in response to rotations of the user that should not cause movement of the virtual content 302. For example, the electronic device 101 operates in a body-locked mode as described previously herein. In some examples, the electronic device 101 optionally operates in the orientation locked mode 401 when the user is moving in a relatively straight trajectory, thereby avoiding moving the virtual content 302 in response to detecting small and/or quick rotations of the user and/or electronic device 101. Movement of the virtual content 302 in the orientation locked mode 401 is described further below with reference to FIGS. 5A-5B.

In some examples, as electronic device 101 operates in the orientation locked mode 401 while the user 301 is moving, electronic device 101 tracks the trajectory vector 305 and orientation vector 306 as described above. In some examples, the electronic device 101 tracks the trajectory vector 305 over time; an angle between the trajectory vector 305 at a first time and the trajectory vector 305 at a second time may indicate that the user has turned relative to the trajectory of the user when the electronic device 101 initiated the orientation locked mode, so the orientation mode needs to be changed in order to update the position of the virtual content 302 relative to the user 301. However, as described above, in some examples, the electronic device 101 forgoes updating the location of the virtual content 302 in response to rotation of the user when the orientation vector 306 and the trajectory vector 305 are more than a threshold angle apart, such as greater than 15 degrees.

Thus, in some examples, the one or more second criteria 404 include (i) a criterion that is satisfied when an angle between the trajectory vector 305 at a first time and the trajectory vector 305 at a second time after the first time exceeds a threshold and (ii) a criterion that is satisfied when an angle between trajectory vector 305 and orientation vector 306 is less than another threshold angle. For example, when the electronic device 101 determines that the one or more second criteria 404 are satisfied, electronic device 101 transitions to the orientation unlocked mode 402 to control the position of the virtual content 302 in the three-dimensional environment 303. For example, the one or more second criteria 404 include a criterion that is satisfied when the trajectory vector 305 changes by at least 15, 20, 30, or 45 degrees over at least a predetermined time relative to the trajectory vector 305 when the electronic device 101 entered the orientation locked mode 401.

In some examples, the electronic device 101 moves the location of virtual content 302 in a second position while operating in orientation unlocked mode 402. In some examples, while operating in the orientation unlocked mode 402, the electronic device 101 updates the position of virtual content 302 to a second position based on both the trajectory of the user and the orientation of the user. In some examples, the electronic device 101 continues to operate in the orientation unlocked mode 402 for a plurality of frames of sensing the trajectory vector 305 and/or orientation vector 306 and/or frames of presenting the virtual content 302 until one or more first criteria 403 are satisfied. The one or more second criteria 404 and movement of the virtual content 302 in the orientation unlocked mode 402 are further explained herein with reference to FIGS. 5A-5F.

In some examples, in response to detecting the one or more first criteria 403 are satisfied while operating in the orientation unlocked mode 402, the electronic device 101 transitions to the orientation locked mode 401. In some examples, the one or more first criteria 403 include a criterion that is satisfied when the angle of the trajectory vector 305 changes by less than a threshold angle for at least a predetermined period of time. In some examples, the threshold angle of the change in the trajectory vector 305 of the one or more first criteria 403 is less than the threshold angle of the change in the trajectory vector 305 of the one or more second criteria 404. For example, the threshold angle of the one or more first criteria 403 is 5, 10, 15, or 25 degrees. In some examples, the threshold period of time is 0.5, 1, or 2 seconds. As an example, the one or more first criteria 403 require that the angle of the trajectory vector 305 changes by less than 15 degrees for one second. For example, when the user stops turning relative to the trajectory of the user when the electronic device 101 initiated the orientation locked mode and moves in a relatively straight trajectory, the electronic device 101 returns to the orientation locked mode 401.

In some examples, the electronic device 101 further includes a third mode orientation mode, the short-term adjustment mode 406. In the short-term adjustment mode 406, the electronic device 101 updates to a third position of the virtual content 302 in accordance with rotation and translation of the user and, after a predetermined duration, returns to the orientation locked mode 401 (e.g., the first position). As shown in FIG. 4, in some examples, the electronic device 101 operates in the short-term adjustment mode 406 in accordance with one or more third criteria 405 being satisfied.

In some examples, the one or more second criteria 404 and the one or more third criteria 405 both include the criterion that is satisfied when the angle between the trajectory vector 305 and the orientation vector 306 are less than the threshold angle described above with respect to the one or more second criteria 404. In some examples, the one or more third criteria 405 further include a criterion that is satisfied when the trajectory vector 305 changes by an angle between a first threshold angle and a second threshold angle over a predefined period of time. In some examples, the first threshold angle is less than the threshold angle the one or more second criteria 404 compare to the change of the trajectory vector 305, such as 5, 10, or 15 degrees. In some examples, the second threshold angle is the threshold angle the one or more second criteria 404 compare to the change of the trajectory vector 305 described above. For example, the first threshold angle is 10 degrees and the second threshold angle is 30 degrees. In this example, electronic device 101 transitions operation to the short-term adjustment mode 406 when electronic device 101 detects that trajectory vector 305 has rotated at least 10 degrees (satisfies one or more third criteria 405) and electronic device 101 transitions operation to the orientation unlocked mode 402 when electronic device 101 detects that trajectory vector 305 has rotated at least 30 degrees (satisfies one or more second criteria 404), provided the angle between the orientation vector 306 and trajectory vector 305 also satisfy the second criteria 404 and/or the third criteria 405. In some examples, this predefined period of time is greater than the predefined period of time over which the one or more second criteria 404 compare the change of the trajectory vector 305, such as 0.5, 1, 2, or 3 seconds. In some examples, the one or more third criteria 405 requiring detecting the change in angle of the trajectory vector 305 for the predetermined time period avoids transitioning to the short-term adjustment mode 406 erroneously, which could cause the virtual content 302 to appear to jitter or otherwise move in a distracting way.

Therefore, in some examples, short-term adjustment mode 406 includes adjusting the position of virtual content 302 to a third position in response to a smaller turn of user 301 relative to the trajectory of the user when the electronic device 101 initiated the orientation locked mode than the turn of the user 301 adjusted using the orientation unlocked mode 402. In some examples, the electronic device 101 operates in the short-term adjustment mode 406 for a predetermined duration, whereas the electronic device 101 operates in orientation unlocked mode 402 for a time that depends on the one or more first criteria 403 being satisfied, as described above. In some examples, the predefined duration of the short-term adjustment mode is a predefined number of frames of measuring the trajectory vector 305 and/or orientation vector 306, frames of evaluating the one or more first criteria 403, the one or more second criteria 404, and/or the one or more third criteria 405, such as 1, 3, or 5 frames. In some examples, the predefined duration of the short-term adjustment mode 406 is a period of time, such as 0.1, 0.5, 1, or 3 seconds. In some examples, short-term adjustment mode 406 acts as a corrective mode to adjust the location of virtual content 302 before resuming the orientation locked mode 401. In some examples, after the predetermined duration has passed, the short-term adjustment mode is complete 407 and the electronic device 101 returns to the orientation locked mode 401.

In some examples, electronic device 101 transitions between orientation modes according to the different sets of criteria. In some examples, orientation locked mode 401 is the default mode of the electronic device 101 while the user is moving. In some examples, electronic device 101 can transition from the orientation locked mode to orientation unlocked mode 402 and/or short-term adjustment mode 406 as described above. In some examples, electronic device 101 operates in orientation locked mode 401 when trajectory vector 305 and orientation vector 306 satisfy one or more first criteria 403 Additionally or alternatively, the electronic device 101 optionally operates in the orientation locked mode 401 when the one or more second criteria 404 and the one or more third criteria 405 are not satisfied. In some examples, when the orientation vector 306 and trajectory vector 305 of the user are not aligned (e.g., have an angle greater than a threshold), electronic device 101 optionally operates in the orientation locked mode 401, thereby avoiding moving the virtual content 302 in a manner that could be distracting or uncomfortable to the user, such as while the user is looking away from the direction in which they are moving. Transitioning between modes in this way controls movement of virtual content 302 while the user and/or electronic device 101 are moving, as further described below in FIGS. 5A-5F.

FIGS. 5A-5F illustrate electronic device 101 displaying virtual content 502 in the various orientation modes according to some examples of the disclosure. As explained previously with reference to FIGS. 3 and 4, electronic device 101 displays virtual content 502 in various orientation modes (e.g., orientation locked mode 401, orientation unlocked mode 402, and short-term adjustment mode 406) and transitions between these modes when certain conditions are satisfied (e.g., one or more first criteria 403, one or more second criteria 404, and one or more third criteria 405).

FIGS. 5A and 5B show user 501 moving in three-dimensional environment 503 while wearing an electronic device 101 that displays virtual content 502 in the default orientation locked mode 401 according to some examples of the disclosure. It is understood that the location of virtual content 502 is a non-limiting presentation of the location of the virtual content and that the virtual content can be displayed at one or more different locations within the display of the three-dimensional environment. In some examples, moving the virtual content 502 in the three-dimensional environment 503 in accordance with movement of the user 501 includes moving the virtual content 502 so that a spatial relationship between the virtual content 502 and the user is in a predefined range, including the spatial relationship illustrated in FIG. 5A. Further, it is understood that the type of virtual content 502 is a non-limiting presentation of the type of the virtual content 502 and that the virtual content can be displayed as one or more different types of content within the display of the three-dimensional environment. For example, the virtual content 502 is optionally one of an application user interface, a system user interface or element, and/or an item of content, such as video content.

FIG. 5A illustrates electronic device 101 being worn by a user 501 and operating in the orientation locked mode 401 as described herein. In some examples, electronic device 101 automatically operates in orientation locked mode 401 when electronic device 101 and/or user are moving and the electronic device 101 displays virtual content 502 configured to follow movements of the user in the three-dimensional environment. For example, when virtual content 502 is configured to follow movements of the user 501, the electronic device 101 operates in the orientation locked mode 401 as a default mode. In some examples, electronic device 101 transitions operation to another orientation mode described herein when the one or more second criteria 404 or the one or more third criteria 405 are satisfied, as described above with reference to FIG. 4 and below with reference to FIGS. 5C-5F.

In some examples, operating in the orientation locked mode 401 includes electronic device 101 displaying virtual content 502 in a body-locked orientation. In some examples, operating in the orientation locked mode 401 includes moving the virtual content 502 in accordance with translation of the user 501 (e.g., corresponding to trajectory vector 305) to maintain a position relative to the user 501 within a predefined range of positions. In some examples, as user 501 walks around three-dimensional environment 503 while wearing electronic device 101, the orientation of the virtual content 302 window is locked so that when user 501 turns their head or torso or performs unintentional rotational movements, the orientation of the virtual content 302 relative to the location of the user 501 (optionally independent from rotation of the user) does not change or move. In some examples, the electronic device 101 optionally operates in the orientation locked mode 401 when the user is moving in a relatively straight trajectory. In some examples, the electronic device 101 optionally operates in the orientation locked mode 401 when the orientation and trajectory of the user are not aligned, thereby avoiding moving the virtual content 302 in a manner that could be distracting or uncomfortable to the user, such as while the user is looking away from the direction in which they are moving.

The example displays of electronic device 101 in FIG. 5B illustrate user movement and its effect on movement of the location of virtual content 502 while operating in orientation locked mode 401. In the first example display 120 shown in FIG. 5B, the hands of user 501 can be seen and/or detected by electronic device 101 as user movements, optionally including rotation, occurring in three-dimensional environment 503. In some examples, arm swinging movements of user 501 may result in small and/or quick rotational movements of user 501 and/or electronic device 101 (small change in orientation vector 306). In some examples, small movements of the orientation vector 306 lead to movement in the location of virtual content 502, such as slight shaking back and forth in accordance with the small and/or quick rotational movements. For example, although the user 501 may rotate when moving in these ways, the one or more second criteria 404 and the one or more third criteria 405, described above with reference to FIG. 4, are not satisfied. While electronic device 101 operates in orientation locked mode 401, in some examples, no slight jolting movements and/or shaking of the location of virtual content 502 occur because the electronic device 101 does not move the virtual content 502 in response to rotational movements of the user in the orientation locked mode 401. In further examples, while operating in orientation locked mode 401, other user movements such as looking around, shaking their head, leg movements, slight torso rotations, or the like, will not cause movement of virtual content 502.

In the second example display shown in FIG. 5B, user 501 performs a head rotation while moving translationally in three-dimensional environment 503. In some examples, the user movement is a rotational movement (e.g., change in orientation vector 306), thus electronic device 101 does not move virtual content 502 in response to this rotation while operating in orientation locked mode 401. In some examples, electronic device 101 does not move or shake virtual content 302 due to user head, torso, or electronic device 101 rotation while operating in orientation locked mode 401. In some examples, when the head rotation of user 501 meets one or more second criteria 404, electronic device 101 will transition operation from the orientation locked mode 401 to the orientation unlocked mode 402, which takes rotational movements of the user into account to move the location of virtual content 502.

Referring back to FIG. 5A, electronic device 101 continuously tracks trajectory vector 305 and orientation vector 306 while operating in orientation locked mode 401 as user 501 moves around three-dimensional environment 503. In some examples, both vectors are measured in the horizontal yaw plane. In some examples, when tracking trajectory vector 305 and orientation vector 306, electronic device 101 reads both vectors as extending from a reference point of the user 501, such as the center of the head or center of the torso. In some examples, electronic device 101 reads both vectors as extending from the center of the electronic device 101 worn on the head of user 501. In some examples, when tracking orientation vector 306, electronic device 101 tracks both the orientation of the torso of user 501 and the orientation of the head of user 501. In some examples, the orientation of the head and the torso of user 501 is detected using one or more cameras and/or sensors. For example, one or more first cameras track the orientation of the torso of user 501 and one or more second cameras different from the one or more first cameras track the orientation of the head of user 501. In some examples, electronic device 101 selects whichever reading of the orientation of the torso of user 501 or the orientation of the head of user 501 is the most accurate, and then use that value as the orientation vector 306. In some examples, to choose the more accurate reading, electronic device 101 assigns each reading of the orientation of the torso of user 501 and the orientation of the head of user 501 a confidence score, respectively; the confidence score is a numerical value indicative of the certainty of the readings. In some examples, electronic device 101 chooses whichever reading (e.g., the head orientation reading or the torso orientation reading) possesses the higher confidence score and will use that reading as the actual vector reading for orientation vector 306.

In some examples, and still referring to FIG. 5A, angle 508 exists between trajectory vector 305 and orientation vector 306. In some examples, while operating in the orientation locked mode 401, angle 508 between trajectory vector 305 and orientation vector 306 is 0 degrees, meaning that trajectory vector 305 and orientation vector 306 are optionally both aligned forward in the same direction when user 501 looking straight forward and moving forward translationally. Though the value of angle 508 between trajectory vector 305 and orientation vector 306 changes as user 501 rotates their head and/or torso while moving in three-dimensional environment 503, electronic device 101 does not move the location of virtual content 502 based on these rotational movements. In some examples, electronic device 101 continues operation in orientation locked mode 401 while angle 508 exceeds a threshold value angle. For example, while operating in orientation locked mode 401, the value of angle 508 is above a threshold value angle of 10 degree, 15 degrees, or the like. In some examples, one or more second criteria 404 and the one or more third criteria 405 include a criterion that is satisfied when angle 508 is below this threshold angle value. Thus, when operating in orientation locked mode 401 and angle 508 is below a threshold value, electronic device 101 optionally transitions from orientation locked mode 401 to orientation unlocked mode 402. However, in some examples, angle 508 having a value below a threshold value angle is not the only criterion needed to be satisfied in order to transition from the orientation locked mode 401 to the orientation unlocked mode 402.

Further, while operating in orientation locked mode 401 in FIGS. 5A-5B, electronic device 101 tracks an angle between the trajectory vector 305 at a first time and the trajectory vector 305 at a second time. In some examples, in the orientation locked mode 401, changes in movement from the trajectory vector 305 at a first time to the trajectory vector 305 at a second time results in movement of the location of virtual content 502 independent of orientation vector 306. In some examples, one or more first criteria 403 for the orientation locked mode 401 includes a criterion that is satisfied when an angle value between the trajectory vector 305 at the first time and at the seconds time is less than a threshold angle value, indicating that the user 501 has not turned their trajectory during the threshold time. By comparing the trajectory vector in two frames captured with a threshold time between apart from each other, the electronic device 101 optionally filters transient rotational motion that should not cause the electronic device 101 to move the virtual content 502

In some examples, electronic device 101 operates in the orientation locked mode 401 by default. That is, in response to detecting movement of the user and in accordance with a determination that the virtual content 302 is configured to move in the three-dimensional environment in accordance with movement of the user, the electronic device 101 displays the virtual content 302 in the orientation locked mode 401 unless and/or until the one or more second criteria 404 or the one or more third criteria 405 are satisfied as described below. Additionally or alternatively, in some examples, the electronic device 101 transitions to the orientation locked mode 401 from another mode as described herein. In some examples, upon entering the orientation locked mode 401 (e.g., by default or when transitioning from another mode), the electronic device 101 detects the trajectory vector 305 at the start of operating in the orientation locked mode 401. As described herein, in some examples, the electronic device 101 compares subsequent values of the trajectory vector 305 to the trajectory vector 305 at the start of operating in the orientation locked mode 401 to determine whether or not to transition to a different mode.

In some examples, electronic device 101 transitions from orientation locked mode 401 to orientation unlocked mode 402 in accordance with a determination that the trajectory vector 305 and/or orientation vector 306 satisfy one or more second criteria 404 described above with reference to FIG. 4. Examples of the electronic device 101 operating in the orientation unlocked mode 402 are described below with reference to FIGS. 5C and 5D.

FIGS. 5C and 5D show user 501 moving in three-dimensional environment 503 while wearing an electronic device 101 that displays virtual content 502 and operates in the orientation unlocked mode 402 according to some examples of the disclosure. In some examples, in the orientation unlocked mode 402, moving the virtual content 502 in the three-dimensional environment 503 in accordance with movement of the user 501 includes moving the virtual content 502 so that a spatial relationship between the virtual content 502 and the user is in a predefined range, including the spatial relationship illustrated in FIG. 5C. Further, it is understood that the type of virtual content 502 is a non-limiting presentation of the type of the virtual content 502 and that the virtual content can be displayed as one or more different types of content within the display of the three-dimensional environment 503.

FIG. 5C illustrates electronic device 101 being worn by a user 501 and operating in the orientation unlocked mode 402 as described herein. In some examples, electronic device 101 transitions from orientation locked mode 401 to orientation unlocked mode 402 when electronic device 101 detects user 501 is going around a large curve or corner relative to the trajectory of the user when the electronic device 101 initiated the orientation locked mode 401.

In some examples, operating in the orientation unlocked mode 402 differs from operating in orientation locked mode 401 in that, during orientation unlocked mode 402, electronic device 101 moves virtual content 502 in accordance with both trajectory vector 305 and orientation vector 306, rather than just trajectory vector 305. In some examples, the electronic device 101 transitions to the orientation unlocked mode 402 in accordance with one or more second criteria 404 being satisfied and continues to operate in the orientation unlocked mode 402 while the one or more first criteria 403 are not satisfied. In some examples, operating in the orientation unlocked mode 402 includes the electronic device 101 displaying virtual content 502 in a head-locked orientation since the location of virtual content 502 has a distance and orientation offset relative to a head or torso of user 501. Once electronic device 101 transitions to orientation unlocked mode 402, virtual content 502 moves location based on the rotational and translational movements of user 501 as illustrated in FIG. 5C. As user 501 follows the dotted line trajectory as shown in FIG. 5C, the location of virtual content 502 moves according to the confident head or torso orientation of user 501, as explained previously herein, so that virtual content 502 is always located in the center of the viewpoint of user 501.

The example displays of electronic device 101 in FIG. 5D illustrates user movement and its effect on movement of the location of virtual content 502 while operating in orientation unlocked mode 402. The example displays of electronic device 101 illustrate the leftward movement of virtual content 502 on display 120 as a result of a leftward head and/or torso rotation of user 501. When electronic device 101 detects that user 501 has turned their head and/or torso to the left while operating in the orientation unlocked mode 402 (e.g., by a rotational change in viewpoint to the left), electronic device 101 will move the location of virtual content 502 to the left of the display as well to keep virtual content 502 within the predefined region of display 120. The leftward movement of virtual content 502 is illustrated on the example displays by the arrow next to virtual content 502 pointing leftward, indicating movement of the virtual content window in that direction. It should be appreciated that operating in the orientation unlocked mode also includes moving the virtual content 502 to the right in response to detecting rotation of the user 501 to the right, for example. Overall, FIG. 5D illustrates the example movement of the viewpoint of user 501 and the subsequent movement of virtual content 502 while electronic device 101 is operating in orientation unlocked mode 402.

Referring back to FIG. 5C, electronic device 101 continuously tracks trajectory vector 305 and orientation vector 306 while operating in orientation unlocked mode 402. In some examples, angle 509 exists between a trajectory vector 305 at a first time and a trajectory vector 305 at a second time. The value therebetween, or the value of angle 509, indicates the change of the trajectory of user 501 over a period of time, as explained previously herein. For example, when the period of time is 1 second, the trajectory vector 305 at a first time is the value of the trajectory vector 305 from 1 second ago. In some examples, the value of angle 509 can indicate how much the translational movement of user 501 has changed directionally in the three-dimensional environment 503 (how much trajectory vector 305 had rotated) over the period of time. In some examples, in accordance with the one or more first criteria 403 being satisfied, the electronic device 101 transitions to the orientation locked mode 401. The one or more first criteria 403 includes a criterion that is satisfied when the value of angle 509 is within a range of values that is less than a threshold angle value as explained previously herein. When the one or more first criteria 403 are not satisfied, the electronic device 101 continues operation in the orientation unlocked mode 402. For example, when angle 509 is greater than the threshold angle of the one or more first criteria 403, the electronic device 101 remains in the orientation unlocked mode 402. As described above with reference to FIG. 4, in response to the one or more first criteria 403 being satisfied, such as angle 509 exceeding the threshold, the electronic device 101 transitions to the orientation locked mode 401.

Still referring to FIG. 5C, in some examples, angle 510 exists between a current value of trajectory vector 305 and a current value of orientation vector 306. In some examples, angle 510 is equivalent to angle 508 previously described herein in FIGS. 5A and 5B. In some examples, a criterion of the one or more second criteria 404 corresponding to transitioning to the orientation unlocked mode 402 is satisfied when the value of angle 510 is less than a threshold angle value or within a threshold angle value range. In some examples, electronic device 101 continues operation in orientation unlocked mode 402 until angle 510 exceeds a threshold angle value. In some examples, electronic device 101 forgoes transitioning to the orientation unlocked mode 402 when angle 510 exceeds the threshold value but, once in the orientation unlocked mode 402, remains in the orientation unlocked mode 402 irrespective of angle 510.

In some examples, electronic device 101 transitions from orientation locked mode 401 to a short-term adjustment mode 406, optionally a variation of orientation unlocked mode 402, in accordance with a determination that the trajectory vector 305 and orientation vector 306 satisfy one or more third criteria 405 described above with reference to FIG. 4. Examples of the electronic device 101 operating in short-term adjustment mode 406 are described below with reference to FIGS. 5E and 5F.

FIGS. 5E and 5F show user 501 moving in three-dimensional environment 503 while wearing an electronic device 101 that displays virtual content 502 and operates in the short-term adjustment mode 406 according to some examples of the disclosure. It is understood that the location of virtual content 502 is a non-limiting presentation of the location of the virtual content and that the virtual content can be displayed from one or more different locations within the display of the three-dimensional environment. In some examples, moving the virtual content 502 in the three-dimensional environment 503 in accordance with movement of the user 501 includes moving the virtual content 502 so that a spatial relationship between the virtual content 502 and the user is in a predefined range, including the spatial relationship illustrated in FIG. 5C. Further, it is understood that the type of virtual content 502 is a non-limiting presentation of the type of the virtual content and that the virtual content can be displayed as one or more different types of content within the display of the three-dimensional environment.

FIG. 5E illustrates electronic device 101 being worn by a user 501 and operating in the short-term adjustment mode 406 as described previously herein. In some examples, electronic device 101 transitions from orientation locked mode 401 to short-term adjustment mode 406 when one or more third criteria 405 are satisfied. In some examples, operating in the short-term adjustment mode 406 is optionally similar to operating in orientation unlocked mode 402. In some examples, electronic device 101 transitions operation to the orientation unlocked mode 402 when user 501 moves around a larger turn in three-dimensional environment 503 relative to the trajectory of the user when the electronic device 101 initiated the orientation locked mode and transitions operation to the short-term adjustment mode 406 when user 501 moves around a smaller, turn in three-dimensional environment 503 relative to the trajectory of the user when the electronic device 101 initiated the orientation locked mode. In some examples, operating in the short-term adjustment mode 406 includes adjusting the movement of the virtual content 502 in the three-dimensional environment 503 in accordance with a small rotational movement of the viewpoint of a user 501 of the electronic device 101 in the three-dimensional environment 503.

In some examples, operating in the short-term adjustment mode 406 includes electronic device 101 displaying virtual content 502 in a head-locked orientation since the location of virtual content 502 to adjust the position of virtual content 502 based on rotation of a head or torso of user 501. As shown in FIG. 5E, user 501 is moving in three-dimensional environment 503. Once electronic device 101 transitions to short-term adjustment mode 406 when the one or more third criteria 405 are satisfied, the electronic device 101 moves virtual content 502 based on the rotational movements (and, optionally, translational) of user 501. As user 501 follows the dotted line trajectory as shown in FIG. 5E, the location of virtual content 502 moves similarly to that of orientation unlocked mode 402. In some examples, short-term adjustment mode 406 differs from orientation unlocked mode 402 in that short-term adjustment mode 406 has a predefined duration, such as a predefined period of time and/or a predefined number of frames of presenting virtual object 502 or sensing vector(s) 305 and/or 306.

In some examples and as shown in FIG. 5E, electronic device 101 tracks angle 511 while operating in the short-term adjustment mode 406. In some examples, angle 511 is equivalent to angle 509 described herein with reference to FIGS. 5C and 5D. In some examples, electronic device 101 transitions into short-term adjustment mode 406 when the one or more third criteria 405 are satisfied, as described above with reference to FIG. 4. In some examples, one or more third criteria 405 include a criterion that is satisfied when the value of angle 511 is greater than a second threshold angle value. In some examples, the second threshold angle is an angle different from the first threshold angle of the one or more second criteria 404. For example, the second threshold angle has a value of 10 degrees. In some examples, the second threshold angle value is a smaller value than the first threshold angle value explained previously in relation to angle 509 in the orientation unlocked mode 402. For example, first threshold angle has a value of 30 degrees while the second threshold angle has a value of 10 degrees. In this example, when angle 512 is less than another threshold described above, electronic device 101 transitions into orientation unlocked mode 402 when angle 511 (e.g., angle 509) has a value above 30 degrees and transitions into short-term adjustment mode 406 when angle 511 has a value above 10 degrees, but below 30 degrees. In some examples, electronic device 101 transitions into short-term adjustment mode 406 when angle 511 has a value above 10 degrees for a threshold period of time. For example, electronic device 101 transitions into short-term adjustment mode 406 when angle 511 has a value above 10 degrees, but below 30 degrees (e.g., user 501 turning slightly relative to the trajectory of the user when the electronic device 101 initiated the orientation locked mode) for 1 second and angle 512 is less than a threshold.

Still referring to FIG. 5E, in some examples, angle 512 exists between a current value of trajectory vector 305 and a current value of orientation vector 306. In some examples, angle 512 is equivalent to angle 508 and angle 510 described herein. In some examples, a criterion of the one or more third criteria 405 corresponding to short-term adjustment mode 406 is satisfied when the value of angle 512 is less than a threshold angle value. In some examples, although the one or more third criteria 405 require angle 512 to be less than a threshold angle to transition to the short-term adjustment mode 406, once operating in the short-term adjustment mode 406, the electronic device 101 operates in the short-term adjustment mode 406 until the short-term adjustment mode 406 is complete, irrespective of the value of angle 512.

Now referring to FIG. 5F, in some examples, the electronic device 101 operates in the short-term adjustment mode 406 for a predetermined time. In some examples, the electronic device 101 transitions from short-term adjustment mode 406 back to orientation locked mode 401 after a predetermined amount of time or a predetermined number of frames, as explained previously herein. In some examples, after operating in short-term adjustment mode 406 for one or more frames (e.g., of orientation measurement, of image generation), electronic device 101 subsequently transitions back to the orientation locked mode 401 in the next frame as illustrated in FIG. 5F.

In some examples, electronic device 101 operates in short-term adjustment mode 406 to make a quick adjustment to the location of virtual content 502 to minimize off-center placement while operating on orientation locked mode 401. After updating the location of virtual content 502 to align with the new trajectory of user 501 in short-term adjustment mode 406, in some examples, electronic device 101 transitions back to orientation locked mode 401 as shown in FIG. 5F. For example, after user 501 turns slightly in the three-dimensional environment 503 relative to the trajectory of the user when the electronic device 101 initiated the orientation locked mode for a threshold amount of time (e.g., operates in the short-term adjustment mode 406), electronic device 101 transitions operation back to the orientation locked mode 401 where the orientation vector 306 no longer affects the movement of the location of virtual content 502.

In some examples, orientation unlocked mode 402 and short-term adjustment mode 406 are both optionally corrective modes and will both subsequently transition back into orientation locked mode 401 once the location of virtual content 502 is adjusted/aligned with the trajectory of user 501.

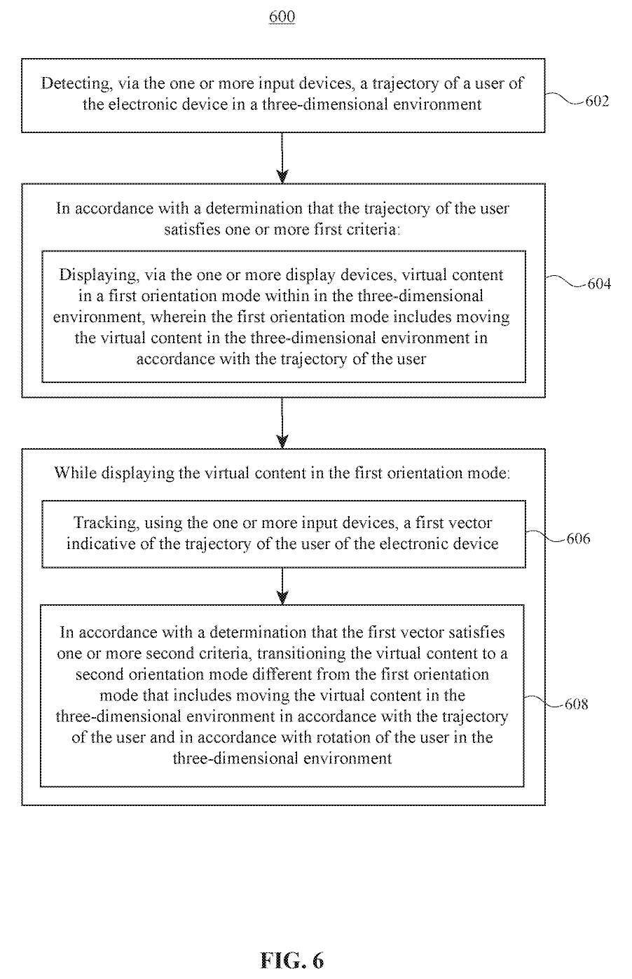

FIG. 6 illustrates a flow diagram illustrating an example process for filtering unwanted motion of a virtual content window based on user movement according to some examples of the disclosure. In some examples, process 600 begins at an electronic device in communication with one or more display devices and one or more input devices. In some examples, the electronic device is optionally a head-mounted display similar or corresponding to electronic device 201 of FIG. 2A or a mobile electronic device similar or corresponding to electronic device 260 of FIG. 2B. As shown in FIG. 6, in some examples, at 602, the electronic device detects, via the one or more input devices, a trajectory of a user of the electronic device in a three-dimensional environment. In some examples, electronic device 101 tracks a trajectory vector 305 as a user moves around the three-dimensional environment, as shown in FIGS. 3, 5A, 5C, 5E and 5F. In some examples, at 604, in accordance with a determination that the trajectory of the user satisfies one or more first criteria, electronic device displays, via the one or more display devices, virtual content in a first orientation mode within in the three-dimensional environment and the first orientation mode includes moving the virtual content in the three-dimensional environment in accordance with the trajectory of the user. In some examples, virtual content 302 is displayed in a default orientation locked mode 401 in FIGS. 3 and 5A. Optionally, while operating in the orientation locked mode 401, the electronic device 101 forgoes moving the virtual content in accordance with rotation of the user.

In some examples, displaying virtual content in first position that is constant with respect to the trajectory of the user is includes to displaying virtual content in the first position based on the first trajectory. In some examples, detecting that the user is turning in the three-dimensional environment and satisfies the criteria to transitions between modes includes detecting that the user movement has changed to a second trajectory, different from the first trajectory. In some examples, the electronic device transitions the virtual content to the second position in accordance with the second trajectory.

As shown in FIG. 6, in some examples, at 606, while displaying the virtual content in the first orientation mode, electronic device tracks, using the one or more input devices, a first vector indicative of movement of the trajectory of movement the user of the electronic device. In some examples, while displaying virtual content in a first position in the orientation locked mode 401, electronic device 101 tracks trajectory vector 305 as a user moves around a three-dimensional environment as shown in FIGS. 3 and 5A. As shown in FIG. 6, in some examples, at 608, while displaying the virtual content in the first orientation mode and in accordance with a determination that the first vector satisfies one or more second criteria, the electronic device transitions the virtual content to a second position in a second orientation mode different from the first position in the first orientation mode that includes moving the virtual content in the three-dimensional environment in accordance with the trajectory of the user and in accordance with rotation of the user in the three-dimensional environment. In some examples, electronic device 101 transitions from orientation locked mode 401 to an orientation unlocked mode 402 when the trajectory vector 305 satisfies one or more second criteria 404. In some examples, while operating in the orientation unlocked mode 402, electronic device 101 moves the virtual content in the three-dimensional environment in accordance with the trajectory of the user and in accordance with rotation of the user in the three-dimensional environment, as shown in FIGS. 5C and 5E. Additionally or alternatively, in some examples, electronic device 101 moves the location of virtual content in a first position while operating in orientation locked mode 401 and in a second position while operating in orientation unlocked mode 402.

It is understood that process 600 is an example and that more, fewer, or different operations can be performed in the same or in a different order. Additionally, the operations in process 600 described above are, optionally, implemented by running one or more functional modules in an information processing apparatus such as general-purpose processors (e.g., as described with respect to FIGS. 2A-2B) or application specific chips, and/or by other components of FIGS. 2A-2B.

Attention is now directed towards another interaction with virtual content windows that are displayed in a three-dimensional environment presented at the electronic device 101. In some examples, instead of transitioning between various operation modes that control how the virtual content window moves in accordance with a user of the electronic device, as previously explained herein with reference to FIGS. 4-6, electronic device 101 moves the location of the virtual content window in accordance with a pose vector. In some examples, as described with reference to FIGS. 7-12, the electronic device 101 updates the pose vector in response to detecting a trajectory/torso vector and head vector of the user aligned with one another at an angle different from the current value of the pose vector. In some examples, electronic device 101 updates the pose vector in response to detecting a trajectory/torso vector and head vector of the user move (e.g., rotate) simultaneously in the same direction and more than threshold distance/angle.

In some examples, the virtual content can be displayed in a window in the three-dimensional environment that follows the rotational and/or translational movement of a user wearing the electronic device within the three-dimensional environment in multiple dimensions. For example, the user walks in a trajectory while wearing the electronic device 101 or sits or stands stationary. In some examples, user movement other than the trajectory and rotation occurs, such as the arm(s) of the user swinging, the head of the user moving, the torso of the user turning, or similar movements, that will cause undesired movement, swaying, or jittering of the virtual content window if the electronic device 101 moves the virtual content window in accordance with these movements. To reduce jittering and/or swaying of the virtual content window, in some examples, electronic device 101 detects a torso/trajectory vector and a head vector of the user of the electronic device to track an overall pose vector of the user. This pose vector controls the movements of the location of virtual content in the three-dimensional environment. For example, when the torso/trajectory vector and a head vector have different angles (e.g., due to differences in movement of the two vectors), the pose vector does not move. Thus, for example, in these situations, the electronic device 101 does not move the location of the virtual content in the three-dimensional environment. However, when the electronic device 101 detects that the torso/trajectory vector and the head vector of the user are aligned and/or have moved (e.g., rotated) simultaneously more than threshold angle, the electronic device 101 updates the pose vector and updates the location of the virtual content in the three-dimensional environment in accordance with the movement of the pose vector. In some examples, the location of the virtual content is updated as the user moves throughout the three-dimensional environment. In some examples, the location of the virtual content is updated after the movement of the user in the three-dimensional environment has dropped below a threshold movement for a threshold period of time.

FIG. 7 illustrates an exemplary three-dimensional environment displayed using one or more displays of an electronic device according to examples of the disclosure. In some examples, electronic device 101 is the same electronic device described previously herein. In some examples, and as illustrated in FIG. 7, electronic device 101 includes display 120 that displays virtual content 702 in a three-dimensional environment 703. It is understood that the location of virtual content 702 is a non-limiting presentation of the location of the virtual content and that the virtual content can be displayed at one or more different locations within the display of the three-dimensional environment.

In some examples, the methods described herein are performed at an electronic device 101. Optionally, electronic device 101 can correspond to electronic device 201 or another device described herein that can display virtual content to a user. Shown in FIG. 7 is also user 701 of electronic device 101. Electronic device 101 displays virtual content 702 to user 701, and the virtual content 702 can be any content described herein, such as the video player shown. FIG. 7 further depicts a bird-eye view (e.g., top-down view) of a three-dimensional environment 703. Three-dimensional environment 703 may be any three-dimensional environment previously described herein. FIG. 7 also illustrates the user 701 wearing the electronic device 101 and head vector 705, torso vector 706, and pose vector 704 detected by the electronic device 101.

In some examples, electronic device 101 tracks a first vector and a second vector. In some examples, the first vector is a head vector 705 tracking the orientation of the head of user 701. In some examples, the second vector is a torso vector 706 tracking the orientation of the torso/trajectory of user 701. In some examples, and shown in FIG. 7, electronic device 101 detects a pose vector 704 of the electronic device 101. In some examples, and as used herein, the pose vector 704 represents the overall orientation of user 701 while wearing electronic device 101 in a first dimension. In some examples, the first dimension is the yaw dimension, as shown by the first image of user 701 in FIG. 7. In some examples, tracking pose vector 704 of the electronic device 101 includes tracking both head vector 705 and torso vector 706. In some examples, electronic device 101 moves pose vector 704 in accordance with movements in the head vector 705 and torso vector 706.

Optionally, the head of user 701 rotates while the user 701 wears electronic device 101. In some examples, electronic device 101 tracks a first vector indicative of the rotational movements of the head of the user 701 of the electronic device 101 that is determined using the one or more input devices, described herein as head vector 705. In the examples of FIGS. 7-12, the first vector is the head vector 705, which differs from the first vector described with reference to FIGS. 3-6 that represents the trajectory vector 305. In some examples, when electronic device 101 is a head-mounted device, rotation of the head of the user causes rotation of the viewpoint of electronic device 101 and rotation of the head vector 705. As indicated in FIG. 7, the head vector 705 may be defined as extending away from a center of the viewpoint of the electronic device 101, such as a center of the display 120. In some examples, electronic device 101 can track the head vector 705 using one or more input devices, such as a camera or another input device mentioned herein. In some examples, an angle of head vector 705 is based on orientation in a first dimension, such as the yaw dimension. Additionally or alternatively, in some examples, an angle of head vector 705 is based on orientation in a second dimension, such as the pitch dimension. In some examples, the angle of head vector 705 is based on rotation in multiple dimensions/directions.

Optionally, the torso of user 701 moves rotationally while the user 701 wears electronic device 101 and while user 701 is stationary in three-dimensional environment 703. In another example, the trajectory of user 701 moves rotationally while wearing electronic device 101 and while user 701 moves translationally in three-dimensional environment 703. In some examples, electronic device 101 tracks a second vector indicative of the rotational movements of the torso and/or trajectory of the user 701 of the electronic device 101 that is determined using the one or more input devices, described herein as torso vector 706. In the examples of FIGS. 7-12, the second vector is torso vector 706, which differs from the second vector described with reference to FIGS. 3-6 that represents the orientation vector 306. Optionally, torso vector 706 may be similar to trajectory vector 305 as described previously herein when user 701 is moving translationally in three-dimensional environment 703. In some examples, the torso vector 706 depends on the direction the user 701 moves, and/or a direction a portion (e.g., torso, head, or face) of the user 701 of the electronic device 101 is facing when not moving translationally in the three-dimensional environment 703. In some examples, the torso vector 706 may be defined as extending away from a center of the viewpoint of the electronic device 101, such as a center of the display 120. In another example and as indicated in FIG. 7, torso vector 706 may be defined as extending away from a center of the chest of user 701, or another body part different from the head. In some examples, electronic device 101 can track the torso vector 706 using one or more input devices, such as a camera or another input device mentioned herein. In some examples, an angle of torso vector 706 is based on orientation in a first dimension, such as the yaw dimension. Additionally or alternatively, in some examples, an angle of torso vector 706 is based on orientation in a second dimension, such as the pitch dimension. In some examples, the angle of torso vector 706 is based on rotation in multiple dimension and/or directions.

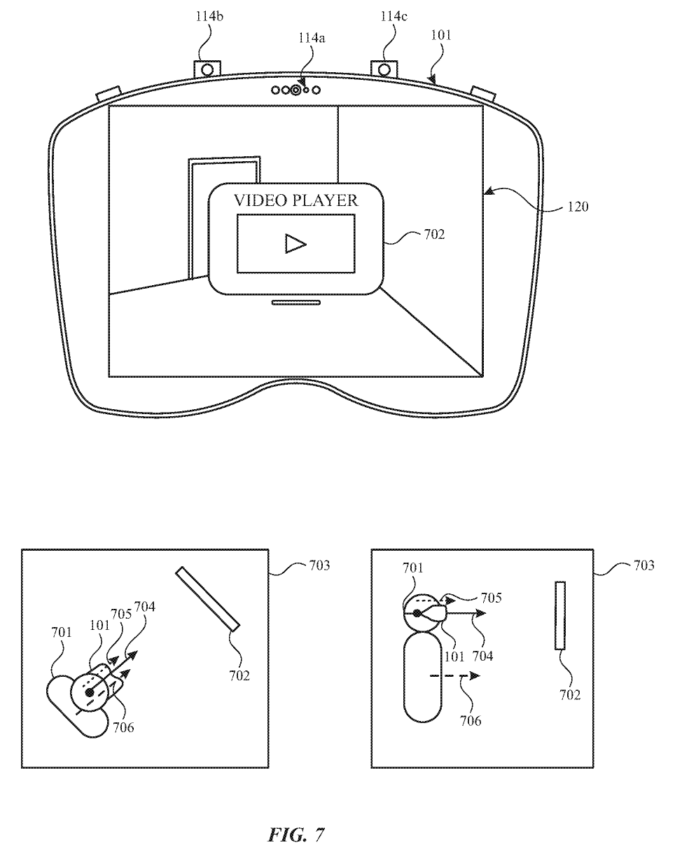

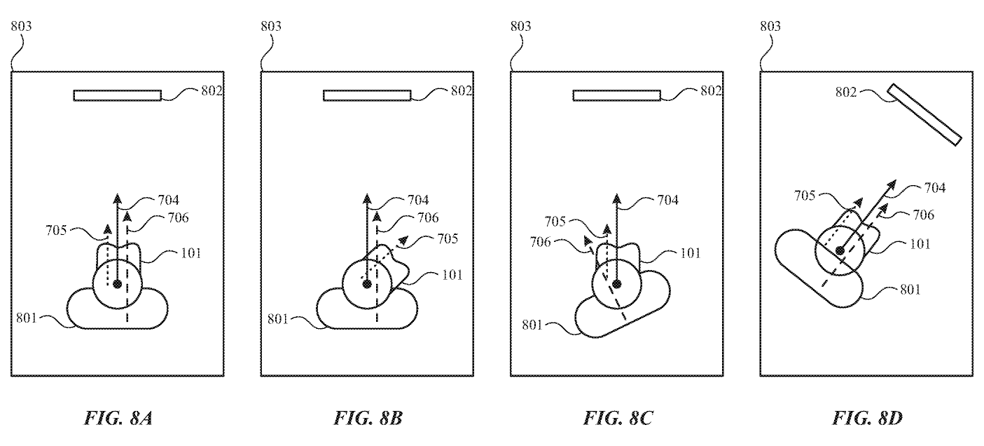

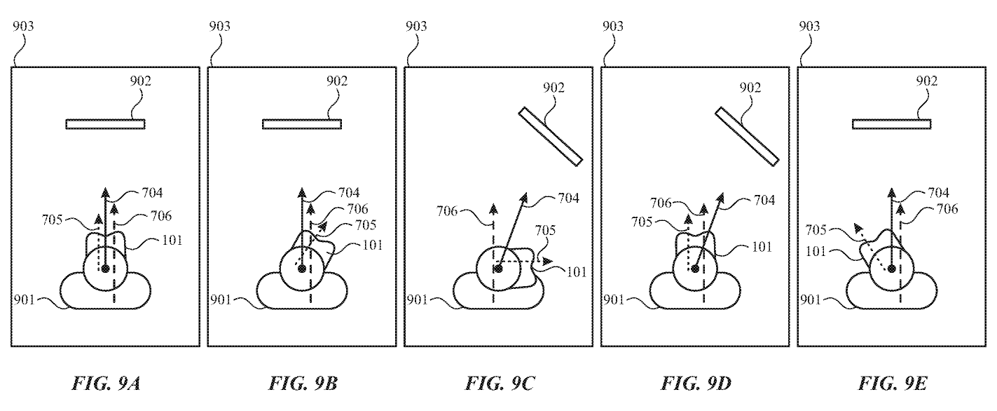

In some examples, electronic device 101 moves pose vector 704 in accordance with changes in the head vector 705 and the torso vector 706 when the head vector 705 and torso vector 706 satisfy one or more criteria. Movement of the pose vector 704 in a first dimension (e.g., yaw) in accordance with the head vector 705 and torso vector 706 is further discussed with references to FIGS. 8-9 below.

In some examples, and referring to FIG. 7, electronic device 101 displays virtual content 702 in a first position within the three-dimensional environment 703. In some examples, the first position of virtual content 702 has a predefined spatial relationship relative to the pose vector 704. The electronic device 101 optionally maintains the predefined spatial relationship when pose vector 704 moves, such as in response to detecting movement of both the head vector 705 and the torso vector 706 while the head vector 705 and pose vector 704 are aligned or both vectors have rotated a threshold angle in the same direction. In some examples, the virtual content 702 moves from the first position to a different position in accordance with the movement of the pose vector 704. In some examples, pose vector 704 moves when the overall orientation of user 701 moves, which includes both the head vector 705 and the torso vector 706 moving while in alignment with each other or while both vectors have rotated a threshold angle in the same direction. For example, when the head vector 705 and torso vector 706 both satisfy one or more specific conditions, such as being aligned with one another and moving simultaneously or both vectors having rotated a threshold angle in the same direction, then the electronic device 101 updates the position of the pose vector 704 in accordance with the movement of the vectors and moves the virtual content 702 to a new, second position within the three-dimensional environment, different than the first position, in accordance with the change in the pose vector 704. In some examples, the virtual content 702 at the second position has the predefined spatial relationship with the pose vector 704.

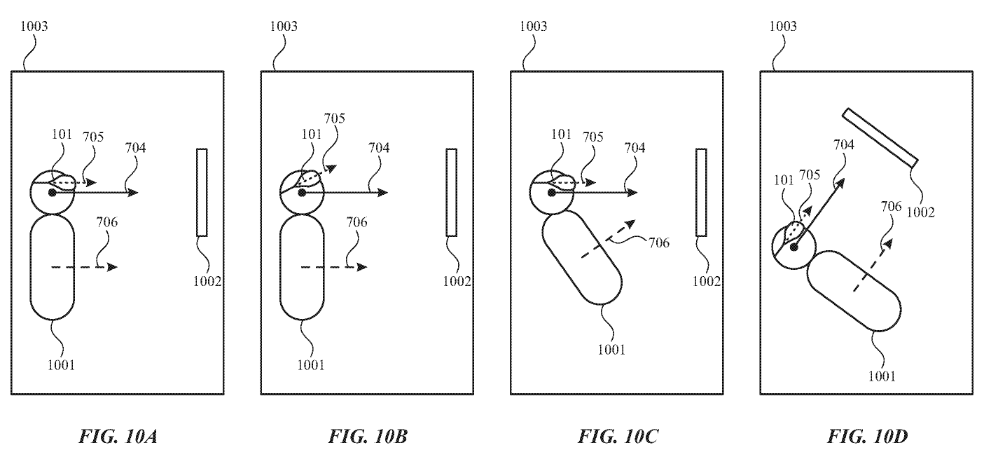

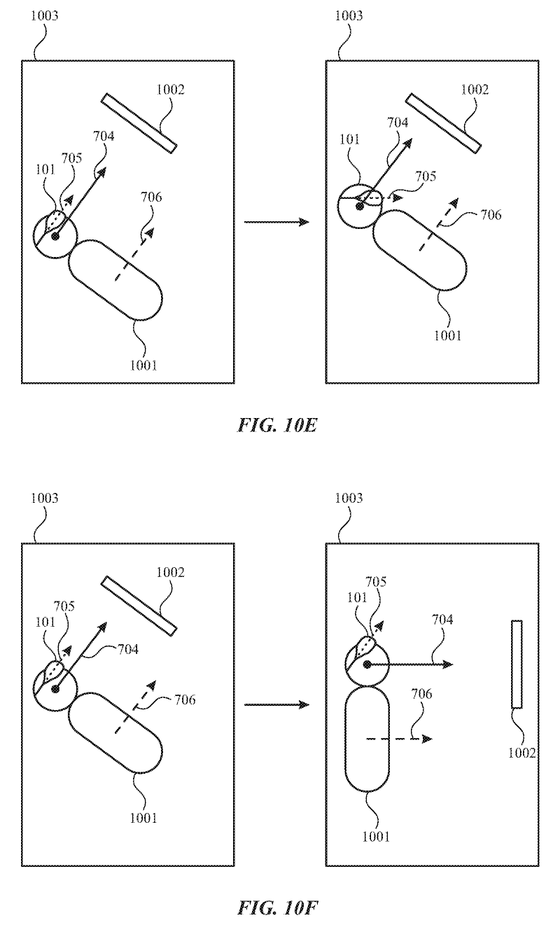

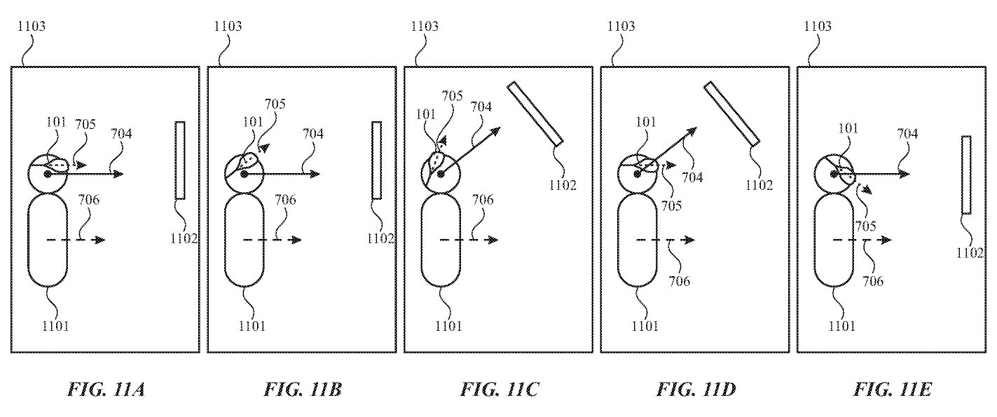

In some examples, pose vector 704 represents the overall orientation of user 701 while wearing electronic device 101 in a second dimension, wherein the second dimension is the pitch dimension as shown by the second image of user 701 in FIG. 7. In some examples, electronic device tracks the vertical rotation of pose vector 704, head vector 705, and torso vector 706 in the three-dimensional environment 703. Movement of the pose vector 704 in a second dimension in accordance with the head vector 705 and torso vector 706 is further discussed with references to FIGS. 10-11 below.

In some examples, electronic device 101 detects torso vector 706 with a high confidence. Detecting torso vector 706 with high confidence means that electronic device 101 tracks the torso vector 706 of user 701 with a high accuracy using the camera and/or sensors and is confident of its reading, for example. FIGS. 8 and 10 herein are examples of electronic device 101 detecting torso vector 706 with a high confidence. In some examples, electronic device 101 detects torso vector 706 with a low confidence. Detecting torso vector 706 with low confidence means that electronic device 101 tracks the torso vector 706 of user 701 with a low accuracy using the camera and/or sensors and is not confident in its reading of the torso orientation, for example. In this scenario, as further explained with reference to FIGS. 9 and 11 below, pose vector 704 is based on head vector 705 without being based on torso vector 706.

FIGS. 8A-8D illustrate sequential top-down views of the user of electronic device while moving (e.g., rotating) in the yaw dimension and in the three-dimensional environment while the electronic device confidently detects the torso of user 801 according to some examples of the disclosure. In some examples, user 801 of electronic device 101 is the same user as user 701 or any other user described herein. It is understood that the location of user 801 and virtual content 802 is a non-limiting presentation of the location of the user and the virtual content and that the user and the virtual content can be displayed at one or more different locations within the display of the three-dimensional environment.

In some examples and as previously explained herein with reference to FIG. 7, electronic device 101 displays virtual content 802 in a first position within the three-dimensional environment 803 with a predefined spatial relationship relative to the pose vector 804. As shown in FIG. 8A, for example, the predefined spatial relationship relative to the pose vector 804 includes displaying virtual content 802 perpendicular to pose vector 704. In some examples, the predefined spatial relationship relative to the pose vector 804 includes updating the location of virtual content 802 in three-dimensional environment 803 according to the movement of pose vector 704, including displaying virtual content 802 perpendicular to pose vector 704 as user 801 moves around three-dimensional environment 803. In some examples, the predefined spatial relationship is preset on electronic device 101 or can be actively changed and/or modified by user 801 on electronic device 101.

In some examples, while displaying virtual content 802 in a first position with the predefined spatial relationship relative to the pose vector 704, as shown in FIG. 8A, electronic device 101 detects a change in the head vector 705 or the torso vector 706 as illustrated in FIGS. 8B and 8C, respectively. However, as illustrated, detecting head vector 705 change without detecting the torso vector 706 change or detecting torso vector 706 change without detecting head vector 705 change causes the electronic device 101 to forgo updating pose vector 704 or the location of virtual content 802. In some examples, pose vector 704, and thus the location of virtual content 802, updates and/or moves in accordance with a determination that the head vector 705 and the torso vector 706 satisfy one or more first criteria. In some examples, one or more first criteria include a criterion that is satisfied when the electronic device 101 detects torso vector 706 with a high confidence, as previous explained herein. In some examples, one or more first criteria include a criterion that is satisfied when the head vector 705 and the torso vector 706 are aligned and move simultaneously, or both vectors have rotated a threshold angle in the same direction. For example, the electronic device 101 maintains the orientation of pose vector 704 in FIG. 8B because the electronic device 101 detects movement of head vector 705 without detecting movement of torso vector 706; thus, the one or more criteria are not satisfied. Similarly, in some examples, the electronic device 101 maintains the orientation of pose vector 704 in FIG. 8C as well because the electronic device 101 detects movement of torso vector 706 without detecting movement of head vector 705; thus, the one or more criteria are not satisfied. The one or more first criteria are further explained below with reference to FIG. 8D.

Referring now to FIG. 8B, while displaying the virtual content 802 in a first position with the predefined spatial relationship relative to the pose vector 704, electronic device 101 detects a change in head vector 705. For example, the user 801 turns their head to the right from the orientation shown in FIG. 8A to the orientation shown in FIG. 8B. In some examples, as illustrated, user 801 in FIG. 8B has not moved their torso compared to user 801 in FIG. 8A, so electronic device 101 detects that a change in head vector 705 has occurred and a change in torso vector 706 has not occurred. Though, in this example, the first criterion of electronic device 101 tracking torso vector 706 in high confidence is satisfied, another first criterion of head vector 705 and torso vector 706 being aligned and moving simultaneously, or that both have rotated a threshold angle in the same direction, is not satisfied. Thus, the one or more first criteria are not satisfied, so the electronic device 101 does not update the pose vector 704 in accordance with movement of the head vector 705 and continues to display virtual content 802 in the first position within in the three-dimensional environment 803.

Continuing to refer to the example illustrated in FIG. 8B, the viewpoint of user 801 moves relative to virtual content 802 because the viewpoint of user 801 moves relative to the three-dimensional environment 803. However, virtual content 802 does not move relative to the three-dimensional environment 803 in this example.

Now referring to FIG. 8C, while displaying the virtual content 802 in a first position with the predefined spatial relationship relative to the pose vector 704, electronic device 101 detects a change in torso vector 706. For example, the user 801 turns their torso to the left from the orientation shown in FIG. 8A to the orientation shown in FIG. 8C. In some examples, as illustrated, user 801 in FIG. 8C has not moved their head compared to user 801 in FIG. 8A, so electronic device 101 detects that a change in torso vector 706 has occurred and a change in the head vector 705 has not occurred. Though, in this example, the first criterion of electronic device 101 tracking torso vector 706 in high confidence is satisfied, another first criterion of head vector 705 and torso vector 706 being aligned and moving simultaneously, or both vectors have rotated a threshold angle in the same direction, is not satisfied. Thus, the one or more first criteria are not satisfied, so the electronic device 101 does not update the pose vector 704 in accordance with movement of the torso vector 706 and continues to display virtual content 802 in the first position within in the three-dimensional environment 803.

In some examples, while displaying virtual content 802 in a first position with the predefined spatial relationship relative to pose vector 704, electronic device 101 detects a change in both head vector 705 and torso vector 706. For example, user 801 rotates their head in the counterclockwise direction a few degrees while user 801 simultaneously rotates their torso in the clockwise direction. In this example, electronic device 101 does not determine that head vector 705 and torso vector 706 satisfies the one or more first criteria because although head vector 705 and torso vector 706 are moving simultaneously, the values the respective vectors are not the same/aligned or both vectors have rotated a threshold angle in the same direction. Thus, in this example, the one or more first criteria are not satisfied and electronic device 101 continues to display virtual content 802 in the first position within in the three-dimensional environment 803 without updating pose vector 704.

Now referring to FIG. 8D, while displaying virtual content 802 in a first position with the predefined spatial relationship relative to pose vector 704, electronic device 101 detects a change in both head vector 705 and torso vector 706. For example, the user 801 rotates their head and torso to the right from the orientation shown in FIG. 8A to the orientation shown in FIG. 8D. In some examples, the values of head vector 705 and torso vector 706 are aligned within the same value, or both vectors have rotated a threshold angle in the same direction. In some examples, the values of head vector 705 and torso vector 706 are aligned when the values of each angle are either the same value, or a value within a threshold angle of 1 degree, 2 degrees, or 5 degrees. In some examples, as illustrated, user 801 in FIG. 8D has moved their head and torso together in the same direction by the same amount compared to user 801 in FIG. 8A. Additionally, in some examples, electronic device 101 is tracking torso vector 706 in high confidence. Thus, the one or more first criteria are satisfied, so the electronic device 101 updates the pose vector 704 in accordance with movement of the head vector 705 and torso vector 706 and updates the position of the pose vector 704 within in the three-dimensional environment 803.

In some examples, head vector 705 and torso vector 706 move simultaneously to adjust the position of the pose vector 704. For example, the user 801 in FIG. 8A rotates both heir head and torso at the same time to the orientations of the head and torso shown in FIG. 8D. Additionally or alternatively, in some examples, head vector 705 and torso vector 706 move individually to adjust the position of the pose vector 704. For example, the user 801 in FIG. 8A rotates their head first to the orientation shown in FIG. 8B, and then sequentially rotates their torso after a period of time to the orientation of user 801 in FIG. 8D, which will update the position of the pose vector 704 once the head vector 705 and torso vector 706 are aligned or both vectors have rotated a threshold angle in the same direction.

In some examples, in accordance with a determination that head vector 705 and torso vector 706 satisfy one or more first criteria, electronic device 101 updates pose vector 704 of the electronic device 101 based on the new position of, or detected change in, the head vector 705 and torso vector 706. Continuing to refer to FIG. 8D, electronic device 101 updates pose vector 704 in response to detecting head vector 705 and torso vector 706 aligned with each other at an orientation different from the orientation of pose vector 704 in FIG. 8A. For example, as shown, head vector 705 and torso vector 706 have both shifted around 45 degrees in the clockwise direction. In some examples, once electronic device 101 detects the change in head vector 705 and torso vector 706 and determines head vector 705 and torso vector 706 satisfy the one or more first criteria, electronic device 101 updates pose vector 704 to be aligned with the new, same value as head vector 705 and torso vector 706. In some examples, once electronic device 101 detects the change in head vector 705 and torso vector 706 and determines head vector 705 and torso vector 706 satisfy the one or more first criteria, electronic device 101 updates pose vector 704 to be aligned with a value that is a function of the head vector 705 and torso vector 706, such as the average value of the two vectors. Thus, in some examples, electronic device 101 updates pose vector 704 to be aligned with the aligned and simultaneous movement of head vector 705 and torso vector 706. In some examples, pose vector 704 mirrors head vector 705 and torso vector 706 as head vector 705 and torso vector 706 satisfy the one or more first criteria.

In some examples, referring still to FIG. 8D, in accordance with a determination that head vector 705 and torso vector 706 satisfy one or more first criteria, electronic device 101 moves the display of virtual content 802 to a second position within the three-dimensional environment 803 based on the updated orientation of pose vector 704. In some examples, this second position is different from the first position but has the same first predefined spatial relationship to pose vector 704. In some examples, electronic device 101 moves the virtual content 802 from the first position shown in FIG. 8A to the second position shown in FIG. 8D. In some examples, the first predefined spatial relationship to pose vector 704 of the second position is that virtual content 802 is displayed perpendicular to pose vector 704 as previously explained. Thus, as electronic device 101 updates pose vector 704, electronic device 101 also moves virtual content 802 with the updated movement of pose vector 704 to maintain the spatial relationship between the virtual content 802 and the pose vector 704 as pose vector 704 moves with head vector 705 and torso vector 706. In some examples, electronic device 101 updates pose vector 704 and moves virtual content 702 in accordance with the updated pose vector 704 when head vector 705 and torso vector 706 satisfy the one or more first criteria. Overall, in some examples, when the criterion that electronic device 101 detects torso vector 706 in high confidence is satisfied, virtual content 802 mirrors the movement of pose vector 704 in three-dimensional environment 803 and does not account for individual movements of head vector 705 or torso vector 706.

Additionally, in FIG. 8D and in some examples, virtual content 802 stays within the center of the viewpoint of user 801 in accordance with the movement of the pose vector 704. As explained previously, when the one or more first criteria are satisfied, the pose vector 704 updates in accordance with the movement of head vector 705 and torso vector 706, and thus has the same value as head vector 705 and torso vector 706 (e.g., or aligned within the same value or both vectors have rotated a threshold angle in the same direction). Therefore, in some examples, virtual content 802 stays in the center of the viewpoint of user 801 as on the display 120 of electronic device 101 as user 801 moves around three-dimensional environment 803.

In some examples, in accordance with a determination that head vector 705 and torso vector 706 do not satisfy one or more first criteria, electronic device 101 continues to display virtual content 802 in the first position within in the three-dimensional environment 803 without updating pose vector 704, as previously described in FIGS. 8B and 8C. For example, if just the head vector 705 or just the torso vector 706 move individually, pose vector 704 is not updated and continues to be displayed at the last position pose vector 704 was updated to as shown by the same locations of virtual content 802 in FIGS. 8A-8C.

In some examples, when electronic device 101 detects movement or a change in the head vector 705 or torso vector 706 so that the one or more first criteria are not satisfied, the electronic device 101 ceases to update pose vector 704 and ceases to move virtual content 802 in accordance with the detected change of the head vector 705 or torso vector 706. In some examples, the electronic device 101 detects that the head vector 705 and torso vector 706 no longer satisfy the one or more first criteria when head vector 705 and torso vector 706 no longer have the same angle in three-dimensional environment 803. For example, once electronic device 101 detects the head vector 705 and the torso vector 706 are no longer aligned with one another (e.g., not within 1, 2, or 5 degrees) or no longer both rotate a threshold angle in the same direction, electronic device 101 will cease movement of virtual content 802 and lock virtual content 802 in the position of the pose vector 704 (e.g., where electronic device 101 last detected the alignment of head vector 705 and torso vector 706).

FIGS. 9A-9E illustrate sequential top-down views of the user of electronic device while moving (e.g., rotating) in the yaw dimension and in the three-dimensional environment and the electronic device does not confidently detect the torso of user 901 (e.g., low confidence) according to examples of the disclosure. In some examples, user 901 of electronic device 101 is the same user as user 701 or user 801 or any other user described herein. It is understood that the location of user 901 and virtual content 902 is a non-limiting presentation of the location of the user and the virtual content and that the user and the virtual content can be displayed at one or more different locations within the display of the three-dimensional environment.

In some examples, as explained previously, electronic device 101 displays virtual content 902 in a first position within the three-dimensional environment 903 with a predefined spatial relationship relative to the pose vector 704. As shown in FIG. 9A, for example, the predefined spatial relationship relative to the pose vector 704 is that virtual content 902 is displayed perpendicular to pose vector 704. In some examples, while displaying virtual content 902 in a first position, as shown in FIG. 9A, electronic device 101 updates pose vector 704 and moves virtual content 802 in accordance with a detected change of the head vector 705 or the torso vector 706 if one or more first criteria are satisfied as described previously with reference to FIGS. 7-8D. As previously explained herein, one or more first criteria include a criterion that is satisfied when electronic device 101 detects torso vector 706 with high confidence, in some examples. Additionally or alternatively, as explained previously, electronic device 101 detects torso vector 706 with a low confidence, in some examples. In some examples, electronic device 101 detects torso vector 706 with a low confidence when the device cannot accurately track torso vector 706 with the one or more sensors and /or cameras used to track torso vector 706. In some examples, when electronic device 101 cannot get an accurate reading for torso vector 706, then the electronic device 101 determines that it is tracking torso vector 706 in low confidence. In some examples, when electronic device 101 tracks torso vector 706 in low confidence, electronic device 101 relies more heavily on the tracking of head vector 705 to update pose vector 704 and move virtual content 902. In some examples, when the criterion that electronic device 101 detects torso vector 706 in high confidence is not satisfied, pose vector 704 is updated in response to individual movement of the head vector 705 once head vector 705 exceeds a threshold angle from pose vector 704. In some examples, the threshold angle is an angular distance between head vector 705 and pose vector 704. In some examples, once the angular distance between head vector 705 and pose vector 704 exceeds this threshold angle, pose vector 704 is updated in response to individual movements of the head vector 705. In some examples, when the criterion that electronic device 101 detects torso vector 706 in high confidence is satisfied, electronic device 101 goes back to using the movements of both head vector 705 and torso vector 706 to adjust the position of pose vector 704 and thus move virtual content 702. Movement of virtual content 902 based on low confidence tracking of torso vector 706 is illustrated in FIGS. 9A-9E and explained below.

In some examples, when the electronic device 101 determines that torso vector 706 is being tracked with low confidence (e.g., does not satisfy a criterion of the one or more first criteria that requires high confidence detection of the torso vector 706), electronic device 101 repositions pose vector 704 in accordance with a detected change in head vector 705 irrespective of an angle of the torso vector 706. For example, the user 901 rotates their head to the right from the orientation shown in FIG. 9A to the orientation shown in FIG. 9B. Similar to FIG. 8B, electronic device 101 does not update pose vector 704 or move virtual content 902 in response to the individual change in head vector 705 and no change in the torso vector 706. In some examples, the movement of head vector 705 from the orientation shown in FIG. 9A to the orientation shown in FIG. 9B does not exceed the threshold angle between head vector 705 and pose vector 704. For example, in FIG. 9B, user 901 rotates their head 20 degrees to the right when the threshold angle is 45 degrees. Because the distance between head vector 705 and pose vector 704 is 20 degrees, which does not exceed the threshold angle value of 45 degrees, then pose vector 704 is not updated. Thus, since the one or more first criteria are not satisfied, the electronic device 101 does not update the pose vector 704 in accordance with movement of the head vector 705 and continues to display virtual content 902 in the first position within in the three-dimensional environment 803.

In another example, the user 901 rotates their head further to the right from the orientation shown in FIG. 9B to the orientation shown in FIG. 9C. In some examples, user 701 continues to move their head further and further away from pose vector 704 and thus the location of virtual content 902 in the three-dimensional environment 903. In some examples, once the head of user 901 rotates so that the angle between the head vector 705 and the pose vector 704 exceeds the threshold angle, electronic device 101 updates pose vector 704 to move in accordance with the movement (e.g., rotation) of head vector 705. For example, electronic device 101 in FIG. 9C moves the pose vector 704 to a location between the previous value of the pose vector 704 and the new value of the head vector 705. In some examples, the threshold angle is 45 degrees. For example, the user 901 in FIG. 9C has moved their head to the right 65 degrees from the value of the pose vector 704 in FIGS. 9A-9B. Since 65 degrees is 20 degrees over the threshold angle of 45 degrees, in some examples, electronic device 101 updates the position of the pose vector 704 by rotating it 20 degrees to the right, and also moves the location of the virtual content 902 to maintain the predefined spatial relationship between the pose vector 704 and the virtual content 902. In some examples, electronic device 101 rotates pose vector 704 by a predefined angle irrespective of how much the head vector exceeds the threshold angle. In some examples, electronic device 101 rotates pose vector 704 by a predefined proportion of the angle between the previous orientation vector and the current head vector. In some examples, as illustrated in FIG. 9C, the electronic device 101 updates the pose vector 704 according to the head vector 705 irrespective of the torso vector 706 when the distance value between the head vector 705 and pose vector 704 is 45 degrees or more (e.g., meets or exceeds the threshold angle). Thus, in accordance with a determination that the electronic device 101 detects the torso vector 706 with low confidence and a determination that an angle between the head vector 705 and the pose vector 704 exceeds a threshold angle, the electronic device 101 repositions the pose vector 704 to a new position in three-dimensional environment 903 in accordance with head vector 705 and moves virtual content 902 in accordance with the updated pose vector 704.

In some examples, the electronic device 101 repositions pose vector 704 according to the head vector 705 until electronic device 101 no longer detects that the angle between the head vector 705 and the pose vector 704 exceeds the threshold angle. For example, the user 901 rotates their head back towards the left from the orientation shown in FIG. 9C to the orientation shown in FIG. 9D. In some examples, after electronic device 101 detects user 901 moves their head to exceed the threshold angle in FIG. 9C, electronic device 101 updates the pose vector 704 in accordance with the movement of head vector 705, as also shown in FIG. 9C. While electronic device 101 detects that the threshold angle is exceeded, the user 901 now moves their head back in the leftward direction in FIG. 9D, for example. However, the pose vector 704 and the location of virtual content 902 do not move since the angle between the head vector 705 and the pose vector 704 does not exceed the threshold angle. For example, the head vector 705 moves to the orientation shown in FIG. 9D so that the angular distance between head vector 705 and pose vector 704 is 20 degrees from the orientation shown in FIG. 9C, wherein the angular distance between head vector 705 and pose vector 704 was 45 degrees. The angle between the head vector 705 and the pose vector 704 in FIG. 9D is now 20 degrees, which does not exceed the threshold angle. Thus, in accordance with a determination that the electronic device 101 detects the torso vector 706 with low confidence and a determination that an angle between the head vector 705 and the pose vector 704 does not exceed a threshold angle, the electronic device 101 does not updates the pose vector 704 and continues to display the virtual content 902 in the same position as shown in FIG. 9C. The orientations of the head of the user 901 and the head vector 705 are the same in FIGS. 9A and 9D, but the orientation of the pose vector 704 is different in FIGS. 9A and 9D as described above, for example. Thus, in these examples, the electronic device 101 displays the virtual content 902 at different locations in the three-dimensional environment 903 in FIGS. 9A and 9D.

In another example, the user 901 continues to further rotate their head leftward from the orientation shown in FIG. 9D to the orientation shown in FIG. 9E. In some examples, user 901 continues to move their head further and further away from pose vector 704 and, thus, the location of virtual content 902 in the three-dimensional environment 903, similar to the head movement shown in FIG. 9C but in the opposite direction. In some examples, once the head of user 901 rotates and the angle between head vector 705 and pose vector 704 exceeds a threshold angle, electronic device 101 updates pose vector 704 to move in accordance with the detected change in head vector 705, as previously explained herein with reference to FIG. 9C. For example, electronic device 101 has moved the head vector 705 so that the angle between head vector 705 and pose vector 704 is now exceeding the threshold angle in FIG. 9E. Since the angle between head vector 705 and pose vector 704 is greater than 45 degrees, then electronic device 101 repositions the pose vector 704 in accordance with the detected change in head vector 705. Thus, in accordance with a determination that the electronic device 101 detects the torso vector 706 with low confidence and a determination that an angle between the head vector 705 and the pose vector 704 exceeds a threshold angle, such as 50 degrees in the example illustrated in FIG. 9E, the electronic device 101 repositions the pose vector 704 to a new position in three-dimensional environment 903 in accordance with head vector 705 and moves virtual content 902 in accordance with the pose vector 704.

In some examples, if electronic device 101 were to confidently detect the torso at any point during the movements of the user described in FIGS. 9A-9E, the electronic device 101 transitions to updating the pose vector 704 based on the aligned movements or simultaneous movements of the head vector 705 and torso vector 706 as described with references to FIGS. 8A-8D. In some examples, the electronic device 101 transitions between back and forth between updating the pose vector based on both head vector 705 and torso vector 706 or just head vector 705 depending on the degree of confidence.

FIGS. 10A-10F illustrate sequential side views of the user of electronic device while moving (e.g., rotating) in a second dimension (e.g., pitch dimension) and in the three-dimensional environment and the electronic device 101 confidently detects the torso of user 1001 (e.g., high confidence) according to examples of the disclosure. In some examples, user 1001 of electronic device 101 is the same user as user 701, 801, or 901 or any other user described herein. It is understood that the location of user 1001 and virtual content 1002 is a non-limiting presentation of the location of the user and the virtual content and that the user and the virtual content can be displayed at one or more different locations within the display of the three-dimensional environment.

In some examples, electronic device 101 detects pose vector 704, and also head vector 705 and torso vector 706, in a second dimension, different from the yaw dimension, wherein the second dimension is the pitch dimension as shown by the second image of user 701 in FIG. 7 and explained herein for FIGS. 10A-10E. In some examples, electronic device 101 tracks the vectors in the yaw dimension only, as explained with reference to FIGS. 8-9. In some examples, electronic device 101 tracks the vectors in the pitch dimension only, as explained with reference to FIGS. 10-11. In some examples, electronic device 101 tracks the vectors in both the yaw and pitch dimensions and is capable of moving the location of virtual content 1002 in both the pitch and yaw dimensions as well. In some examples, the behavior of the electronic device 101 in the yaw dimension as described herein with reference to FIGS. 8-9 is the same behavior of electronic device 101 in the pitch directions of FIGS. 10A-10C. In some examples, the behavior of the electronic device 101 in the pitch dimension differs from the behavior in the yaw dimension; for example, as described below with reference to FIG. 10F.

FIG. 10A illustrates user 1001 wearing electronic device 101 while electronic device 101 displays virtual content 1002 in a first position within the three-dimensional environment 1003 with a predefined spatial relationship relative to the pose vector 704. Referring now to FIG. 10B, and similar to FIG. 8B, the user 1001 turns their head in the upward direction from the orientation shown in FIG. 10A to the orientation shown in FIG. 10B. In some examples, as illustrated, user 1001 in FIG. 10B has not moved their torso compared to user 1001 in FIG. 10A, so electronic device 101 detects that a change in head vector 705 has occurred and a change in torso vector 706 has not occurred. Though, in this example, the first criterion of electronic device 101 tracking torso vector 706 in high confidence is satisfied, another criterion of the one or more first criterion, that head vector 705 and torso vector 706 are aligned or both vectors have rotated a threshold angle in the same direction, is not satisfied. Thus, the electronic device 101 does not update the pose vector 704 in accordance with movement of the head vector 705 and continues to display virtual content 1002 in the first position within in the three-dimensional environment 1003.

Continuing to refer to the example illustrated in FIG. 10B, the viewpoint of user 1001 moves relative to virtual content 1002 because the head of user 1001 moves relative to the three-dimensional environment 1003. However, virtual content 1002 does not move relative to the three-dimensional environment 1003 in this example, similar to the yaw direction as explained previously herein. Thus, the spatial relationship between the viewpoint of the user 1001 and the virtual content 1002 is different in FIG. 10B than it was in FIG. 10A, though the virtual content 1002 remains fixed in the three-dimensional environment 1003.

Now referring to FIG. 10C, while displaying the virtual content 1002 in a first position with the predefined spatial relationship relative to the pose vector 704, electronic device 101 detects a change in torso vector 706. For example, the user 1001 turns their torso in an upward direction from the orientation shown in FIG. 10A to the orientation shown in FIG. 10C. For example, the user 1001 reclines. In some examples, as illustrated, user 1001 in FIG. 10C has not moved their head compared to user 1001 in FIG. 10A, so electronic device 101 detects that a change in torso vector 706 has occurred and a change in the head vector 705 has not occurred. Thus, the one or more first criteria are not satisfied, so the electronic device 101 does not update the pose vector 704 in accordance with movement of the torso vector 706 and continues to display virtual content 1002 in the first position within in the three-dimensional environment 1003.

In some examples, while displaying virtual content 1002 in a first position with the predefined spatial relationship relative to pose vector 704, electronic device 101 detects a change in both head vector 705 and torso vector 706. For example, user 1001 rotates their head in the upward direction a few degrees while user 1001 simultaneously rotates their torso in the downward direction. In this example, electronic device 101 does not determine that head vector 705 and torso vector 706 satisfy the one or more first criteria because although head vector 705 and torso vector 706 are moving simultaneously, the values of the respective vectors are not the same/aligned or both vectors have rotated a threshold angle in the same direction. Thus, in this example, the one or more first criteria are not satisfied and electronic device 101 continues to display virtual content 1002 in the first position within in the three-dimensional environment 1003 without updating pose vector 704.

Now referring to FIG. 10D, while displaying virtual content 1002 in a first position with the predefined spatial relationship relative to pose vector 704, electronic device 101 detects a change in both head vector 705 and torso vector 706 in the pitch direction. For example, the user 1001 rotates their head and torso in the upward direction from the orientation shown in FIG. 10A to the orientation shown in FIG. 10D. In some examples, the values of head vector 705 and torso vector 706 are aligned when the values of each angle are either the same value, or a value within 1 degree, 2 degrees, or 5 degrees. In some examples, as illustrated, user 1001 in FIG. 10D has moved their head and torso together in the same direction by the same amount compared to user 1001 in FIG. 10A, thus electronic device 101 detects that the one or more first criteria are satisfied. Additionally, in some examples, electronic device 101 is tracking torso vector 706 in high confidence. Thus, the one or more first criteria are satisfied, so the electronic device 101 updates the pose vector 704 in accordance with movement of the head vector 705 and torso vector 706 and updates the position of the pose vector 704 within in the three-dimensional environment 1003.

In some examples, head vector 705 and torso vector 706 move simultaneously to adjust the position of the pose vector 704. Additionally or alternatively, in some examples, head vector 705 and torso vector 706 move individually to reach the orientations shown in FIG. 10D. For example, the user 1001 in FIG. 10A rotates their head first to the orientation shown in FIG. 10B, and then rotates their torso after a period of time to the orientation of user 1001 in FIG. 10D, which will update the position of the pose vector 704 once the head vector 705 and torso vector 706 are aligned or both vectors have rotated a threshold angle in the same direction and move the value of the pose vector 704 and thus the position of virtual content 1002 in the upward direction in accordance with this detected change.

In some examples, as electronic device 101 updates pose vector 704, electronic device 101 also moves virtual content 1002 with the updated movement of pose vector 704 to maintain the spatial relationship between the virtual content 1002 and the pose vector 704 as pose vector 704 moves with head vector 705 and torso vector 706, as shown in FIG. 10D. In some examples, electronic device 101 updates pose vector 704 and moves virtual content 702 in accordance with the updated pose vector 704 when head vector 705 and torso vector 706 satisfy the one or more first criteria. Overall, in some examples, when the criterion that electronic device 101 detects torso vector 706 in high confidence is satisfied, virtual content 1002 mirrors the movement of pose vector 704 in three-dimensional environment 1003 and does not account for individual movements of head vector 705 or torso vector 706.

In some examples, in accordance with a determination that head vector 705 and torso vector 706 do not satisfy one or more first criteria, electronic device 101 continues to display virtual content 1002 in the first position within in the three-dimensional environment 1003 without updating pose vector 704, as previously described in FIGS. 8B and 8C. In some examples, when electronic device 101 detects movement or a change in the that head vector 705 or torso vector 706 no longer satisfy the one or more first criteria, the electronic device 101 ceases to update pose vector 704 and ceases to move virtual content 1002 in accordance with the detected change. For example, when the electronic device 101 detects that the head vector 705 and torso vector 706 no longer have the same value/are aligned or both vectors have rotated a threshold angle in the same direction, electronic device 101 tracks which location virtual content 1002 is when head vector 705 and torso vector 706 began to deviate from one another or move separately, and locks the position of virtual content 1002 at that location until electronic device 101 detects that the one or more first criteria are satisfied and updates pose vector 704 again.

In some examples, the electronic device 101 detects that the user 1001 of the electronic device 101 is in a reclined state when both the head vector 705 and the torso vector 706 are aligned at an upward angle relative to gravity. Additionally or alternatively, in some examples, the electronic device 101 detects that the user 1001 of the electronic device 101 is in a reclined state when both the head vector 705 and the torso vector 706 are aligned at a downward angle relative to gravity. In some examples, a reclined state of user 1001 refers to the state of electronic device 101 when the head vector 705 and the torso vector 706 are aligned and both facing in an upward or downward direction. In some examples, the reclined state indicates that user 1001 is no longer standing, but may be laying down. For example, when head vector 705 and torso vector 706 are both aligned and facing an upward direction, as shown in FIG. 10D, electronic device 101 detects that user 1001 is in a recline state.

In some examples, and in accordance with a determination that the user 1001 of the electronic device 101 is in a reclined state, as shown in FIG. 10D, electronic device 101 moves the display of virtual content 1002 in the three-dimensional environment 1003 in accordance with the torso vector 706 irrespective of the head vector 705, as shown in FIGS. 10E-10F. For example, the user 1001 rotates their head in the downward direction from the orientation shown in FIG. 10D to the orientation shown in FIG. 10E. In some examples, because electronic device 101 detects that a change in the head vector 705 has occurred and that a change in the torso vector 706 has not occurred while user 1001 is in a reclined state, electronic device 101 does not update the pose vector 704 nor move the virtual content 1002 in accordance with the detected change in head vector 705, as shown in the image on the right in FIG. 10E.

Additionally or alternatively, in some examples, user 1001 rotates their torso in the downward direction from the orientation shown in FIG. 10D to the orientation shown in FIG. 10F. In some examples, because electronic device 101 detects that a change in the torso vector 706 has occurred and that a change in the head vector 705 has not occurred while user 1001 is in a reclined state, electronic device 101 updates the pose vector 704 and moves the location/position of the virtual content 1002 in accordance with the detected downward change in the torso vector 706. Thus, while electronic device 101 detects the vectors in the pitch dimension and detects that user 1001 is in a reclined state, electronic device 101 moves the display of virtual content 1002 in the three-dimensional environment 1003 in accordance with the torso vector 706 irrespective of the head vector 705 when electronic device 101 determines the user 1001 is in a recline state or laying down, as shown in the image on the right in FIG. 10F.

FIGS. 11A-11E illustrate sequential side views of the user of electronic device while moving (e.g., rotating) in the pitch dimension and in the three-dimensional environment, and the electronic device does not confidently detect the torso of user 1101 (e.g., low confidence) according to examples of the disclosure. In some examples, user 1101 of electronic device 101 is the same user as user 701, 801, 901, or 1001 or any other user described herein. It is understood that the location of user 1101 and virtual content 1102 is a non-limiting presentation of the location of the user and the virtual content and that the user and the virtual content can be displayed at one or more different locations within the display of the three-dimensional environment. In some examples, the behavior of electronic device 101 described herein for FIGS. 11A-11E for low confidence tracking in the pitch dimension mirrors the behavior described in FIGS. 9A-9E for low confidence tracking in the yaw dimension.

In some examples, as explained previously, electronic device 101 displays virtual content 1102 in a first position within the three-dimensional environment 1103 with a predefined spatial relationship relative to the pose vector 704. In some examples, when the electronic device 101 determines that torso vector 706 is being tracked in low confidence—thus, the one or more first criteria are not satisfied—electronic device 101 repositions pose vector 704 in accordance with a detected change in head vector 705 irrespective of the torso vector 706. For example, the user 1101 rotates their head upward from the orientation shown in FIG. 11A to the orientation shown in FIG. 11B. Similar to FIG. 10B, electronic device 101 does not update pose vector 704 or move virtual content 1102 in response to the individual change in head vector 705 and no change in the torso vector 706 because the angle between the head vector 705 and the pose vector 704 is less than a threshold angle.

In another example, the user 1101 rotates their head further upward from the orientation shown in FIG. 11B to the orientation shown in FIG. 11C. In some examples, user 1101 continues to move their head further and further away from pose vector 704 and thus the location of virtual content 1102 in the three-dimensional environment 1103. To ensure the virtual content stays within the viewpoint of user 1101, in some examples, electronic device 101 updates pose vector 704 to move in accordance with the detected changed in head vector 705 once the head of user 1101 rotates and the angle between head vector 705 and pose vector 704 exceeds a threshold angle. For example, FIG. 11C, the electronic device 101 moves the pose vector 704 in parallel with the head vector 705 to a location between the previous value of the pose vector 704 (e.g., pose vector 704 as shown in FIGS. 11A-11B) and the new value of the head vector 705 (e.g., head vector shown in FIG. 11C). Additionally or alternatively, in some examples, the threshold angle is 45 degrees, as explained previously herein. In some examples, the threshold angle in the pitch dimension described herein is the same as the threshold angle in the yaw dimension as described with reference to FIGS. 9A-9E. In some examples, the threshold angle is any other preset value, such as 20 degrees, 60 degrees, 90 degrees, etc. For example, the user 1101 in FIG. 11C has moved their head in the upward direction 65 degrees from the position of the head of the user 1101 in FIG. 11A, at which time pose vector 704 and head vector 705 were aligned or both vectors have rotated a threshold angle in the same direction. Since 65 degrees is 20 degrees over the distance threshold value of 45 degrees, in some examples, electronic device 101 updates the position of the pose vector 704 by shifting it 20 degrees upward, and also moves the location of the virtual content 902 by shifting it 20 degrees upward in accordance with the detected change in the head vector 705. In some examples, as illustrated in FIG. 11C, the electronic device 101 updates the pose vector 704 according to the head vector 705 irrespective of torso vector 706 when the distance value between the head vector 705 and pose vector 704 is 45 degrees or more (e.g., meets or exceeds the threshold distance value).

In some examples, the electronic device 101 repositions pose vector 704 according to the head vector 705 until electronic device 101 no longer detects that the angle between the head vector 705 and the pose vector 704 exceeds the threshold angle. For example, the user 1101 rotates their head downward from the orientation shown in FIG. 11C to the orientation shown in FIG. 11D. In response to detecting the user 1101 rotate their head, the electronic device 101 updates the head vector 705 as shown in FIG. 11D. However, as shown in FIG. 11D the pose vector 704 and the location of virtual content 902 do not move from the orientations in FIG. 11C since the angle between the head vector 705 and the pose vector 704 in FIG. 11D does not exceed the threshold angle. For example, the head vector 705 moves to the orientation shown in FIG. 11D so that the angular distance between head vector 705 and pose vector 704 is 20 degrees from the orientation shown in FIG. 11C, wherein the angular distance between head vector 705 and pose vector 704 was 45 degrees. The orientations of the head of the user 1101 and the head vector 705 are the same in FIGS. 11A and 11D, but the orientation of the pose vector 704 is different in FIGS. 11A and 11D as described above, for example. Thus, in these examples, the electronic device 101 displays the virtual content 1102 at different locations in the three-dimensional environment 1103 in FIGS. 11A and 11D.

In another example, the user 1101 continues to further rotate their head downward from the orientation shown in FIG. 11D to the orientation shown in FIG. 11E. In some examples, user 1101 continues to move their head further and further away from pose vector 704 (e.g., downward) and thus the location of virtual content 1102 in the three-dimensional environment 1103, similar to the head movement shown from FIGS. 11A-11C, but in the opposite direction. In some examples, once the head of user 1101 rotates to the point that the angle between head vector 705 and pose vector 704 exceeds a threshold angle, electronic device 101 updates pose vector 704 to move in accordance with the detected changed in head vector 705, as previously explained herein with reference to FIG. 11C. For example, electronic device 101 has moved the head vector 705 so that the angle between head vector 705 and pose vector 704 is now exceeding the threshold angle in FIG. 9E. For example, since the angle between head vector 705 and pose vector 704 is greater than 45 degrees, then electronic device 101 repositions the pose vector 704 in accordance with the detected change in head vector 705. As explained previously, in accordance with a determination that the head vector 705 and the torso vector 706 do not satisfy one or more first criteria, the electronic device 101 continues to display virtual content in a first position within in the three-dimensional environment without updating the pose vector in the pitch dimension.

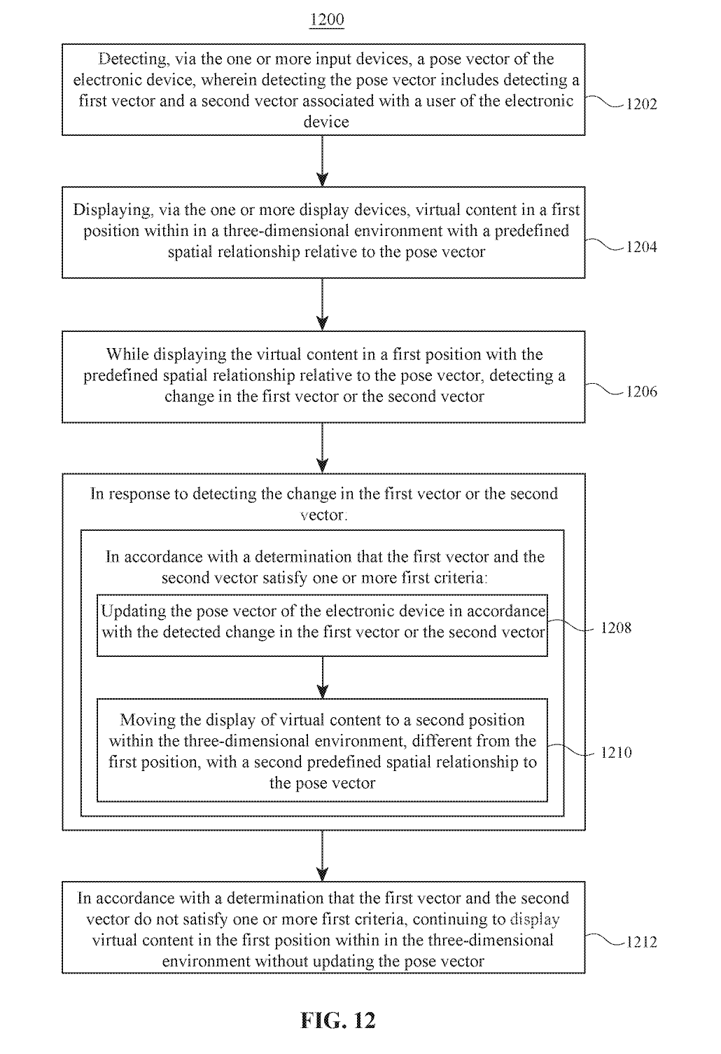

FIG. 12 illustrates a flow diagram illustrating an example process 1200 for filtering unwanted motion of a virtual content window based on user movement according to some examples of the disclosure. In some examples, process 1200 begins at an electronic device (e.g., electronic device 101) in communication with one or more display devices and one or more input devices. In some examples, the electronic device is optionally a head-mounted display similar or corresponding to electronic device 201 of FIG. 2A or a mobile electronic device similar or corresponding to electronic device 260 of FIG. 2B or electronic device 101 as described elsewhere in the application. As shown in FIG. 12, in some examples, at 1202, the electronic device detects, via the one or more input devices, a pose vector (e.g., pose vector 704) of the electronic device, wherein detecting the pose vector includes detecting a first vector (e.g., head vector 705) and a second vector (e.g., torso vector 706) associated with a user of the electronic device. In some examples, electronic device 101 tracks a pose vector 704 including head vector 705 and torso vector 706 as a user moves around the three-dimensional environment, as shown in FIGS. 7-11. In some examples, at 1204, the electronic device displays, via the one or more display devices, virtual content in a first position within in a three-dimensional environment with a predefined spatial relationship relative to the pose vector (e.g., pose vector 704). In some examples, the virtual content in a first position is shown in FIGS. 7, 8A, 9A, 10A and 11A. As shown in FIG. 12, in some examples, at 1206, while displaying the virtual content in a first position with the predefined spatial relationship relative to the pose vector, the electronic device detects a change in the first vector (e.g., head vector 705) or the second vector (e.g., torso vector 706). In some examples, the detected change is each respective vector moving individually or the head vector 705 and torso vector 706 move aligned and together or both vectors have rotated a threshold angle in the same direction.

As shown in FIG. 12, in some examples, at 1208, in response to detecting the change in the first vector (e.g., head vector 705) and/or the second vector (e.g., torso vector 706), and in accordance with a determination that the first vector (e.g., head vector 705) and the second vector (e.g., torso vector 706) satisfy one or more first criteria, the electronic device updates the pose vector (e.g., pose vector 704) of the electronic device in accordance with the detected change in the first vector (e.g., head vector 705) or the second vector (e.g., torso vector 706). In some examples, virtual content is aligned to be perpendicular to the pose vector 704, as shown in FIGS. 8D, 9C, 10D, and 11C. As shown in FIG. 12, in some examples, at 1210, in response to detecting the change in the first vector (e.g., head vector 705) or the second vector (e.g., torso vector 706), and in accordance with a determination that the first vector (e.g., head vector 705) and the second vector (e.g., torso vector 706) satisfy one or more first criteria, the electronic device moves the display of virtual content to a second position within the three-dimensional environment, different from the first position, with the first predefined spatial relationship to the pose vector (e.g., pose vector 704). In some examples, the second position is shown in FIGS. 8D, 9C, 10D and 11C. Lastly, as shown in FIG. 12, in some examples, at 1212, in accordance with a determination that the first vector (e.g., head vector 705) and the second vector (e.g., torso vector 706) do not satisfy one or more first criteria, the electronic device continues to display virtual content in the first position within in the three-dimensional environment without updating the pose vector (e.g., pose vector 704). In some examples, the electronic device continues to display the virtual content at the first position is shown in FIGS. 8B-8C, 9B, 10B-10C and 11B.

It is understood that process 1200 is an example and that more, fewer, or different operations can be performed in the same or in a different order. Additionally, the operations in process 1200 described above are, optionally, implemented by running one or more functional modules in an information processing apparatus such as general-purpose processors (e.g., as described with respect to FIGS. 2A-2B) or application specific chips, and/or by other components of FIGS. 2A-2B.

It is understood that the examples shown and described herein are merely exemplary and that additional and/or alternative elements may be provided within the three-dimensional environment for filtering unwanted motion of a virtual content window based on user movement. It should be understood that the appearance, shape, form, and size of each of the various user interface elements and objects shown and described herein are exemplary and that alternative appearances, shapes, forms and/or sizes may be provided. For example, the virtual content window (e.g., virtual content 502) may be provided in alternative shapes than those shown, such as a rectangular shape, circular shape, triangular shape, etc. In some examples, the various orientation modes (e.g., orientation locked mode 401, orientation unlocked mode 402, and short-term adjustment mode 406) described herein may be transitioned to in response to detection of specific conditions being satisfied (e.g., one or more first criteria 403, one or more second criteria 404, and one or more third criteria 405). Additionally or alternatively, in some examples, the various options, user interface elements, control elements, etc. described herein may be selected and/or manipulated via user input received via one or more input devices in communication with the electronic device (or electronic devices). For example, selection input may be received via physical input devices, such as a mouse, trackpad, keyboard, etc. in communication with the electronic devices (or electronic devices), or a physical button integrated with the electronic devices (or electronic devices).

Therefore, according to the above, some examples of the disclosure are directed to a method, at an electronic device in communication with one or more display devices and one or more input devices, wherein the electronic device is configured to detect, via the one or more input devices, a first trajectory of a user of the electronic device in a three-dimensional environment, wherein the trajectory is based on a direction of a user movement; displaying, via the one or more display devices, virtual content in a first position within in the three-dimensional environment based on the first trajectory of the user; detecting that the user movement has changed to a second trajectory different from the first trajectory; and transitioning the virtual content to a second position different from the first position in accordance with the second trajectory in the three-dimensional environment.

Additionally or alternatively, in some examples, while displaying the virtual content in the first position, and in accordance with a determination that a first vector satisfies one or more first criteria, the electronic device transitions the virtual content to a third position different from the second position in accordance with the second trajectory in the three-dimensional environment. Additionally or alternatively, in some examples, a criterion of the one or more first criteria is satisfied when an angle between the first vector and a second vector indicative of a user orientation of the electronic device is less than a threshold angle. Additionally or alternatively, in some examples, the electronic device transitioning the virtual content to the third position includes: moving the virtual content in the three-dimensional environment in accordance with the first trajectory of the user and in accordance with the second trajectory in the three-dimensional environment for a predetermined duration; and after the predetermined duration since transitioning the virtual content to the third position, transitioning the virtual content to the first position. Additionally or alternatively, in some examples, transitioning the virtual content to the third position includes moving the virtual content in the three-dimensional environment in accordance with the first trajectory of the user and in accordance with the second trajectory in the three-dimensional environment while a rate of change of the trajectory of the user is less than a threshold angle over a second predetermined duration, greater than the predetermined duration. Additionally or alternatively, in some examples, transitioning the virtual content to a second position different from the first position in accordance with the second trajectory in the three-dimensional environment includes an angle between a current value of the first vector and a respective previous value of the first vector in the first position that is greater than a first threshold angle.

Additionally or alternatively, in some examples, while displaying the virtual content in the first position: in accordance with a determination that the first vector satisfies one or more first criteria, including a criterion that is satisfied when the angle between the current value of the first vector and the respective previous value of the first vector in the first position is greater than a second threshold angle for a predetermined period of time, the electronic device transitions the virtual content to a third position different from the second position in accordance with the second trajectory in the three-dimensional environment. Additionally or alternatively, in some examples, the first threshold angle is greater than the second threshold angle. Additionally or alternatively, in some examples, while displaying the virtual content in the second position: in accordance with a determination that the first vector satisfies one or more first criteria, including a criterion that is satisfied when an angle between a current value of the first vector and a respective previous value of the first vector is less than a predefined threshold angle, the electronic device transitions the virtual content to the first position.

Therefore, according to the above, some examples of the disclosure are directed to a method, at an electronic device in communication with one or more display devices and one or more input devices, wherein the electronic device is configured to detect, via the one or more input devices, a pose vector of the electronic device, wherein detecting the pose vector includes detecting a first vector and a second vector associated with a user of the electronic device; display, via the one or more display devices, virtual content in a first position within in a three-dimensional environment with a predefined spatial relationship relative to the pose vector; while displaying the virtual content in a first position with the predefined spatial relationship relative to the pose vector, detecting a change in the first vector or the second vector; in response to detecting the change in the first vector or the second vector: in accordance with a determination that the first vector and the second vector satisfy one or more first criteria: update the pose vector of the electronic device in accordance with the detected change in the first vector or the second vector; move the display of virtual content to a second position within the three-dimensional environment, different from the first position, with a first predefined spatial relationship to the pose vector; and in accordance with a determination that the first vector and the second vector do not satisfy one or more first criteria, continuing to display virtual content in the first position within in the three-dimensional environment without updating the pose vector.

Additionally or alternatively, in some examples, detecting the second vector associated with a user of the electronic device includes detecting an orientation of a torso of the user when stationary. Additionally or alternatively, in some examples, detecting the second vector associated with a user of the electronic device includes detecting an orientation of a trajectory of the user when moving translationally in the three-dimensional environment.

Additionally or alternatively, in some examples, the method further comprises in response to detecting the change in the first vector or the second vector: in accordance with a determination that the second vector does not satisfy a criterion of the one or more first criteria: in accordance with a determination that an angle between the first vector and the pose vector exceeds a threshold: repositioning the pose vector of the electronic device in accordance with the first vector; and moving the display of virtual content to a third position within the three-dimensional environment, different from the first position and the second position, with a third predefined spatial relationship to the pose vector; and in accordance with a determination that the angle between the first vector and the pose vector is less than the threshold, continuing to display virtual content in the first position within in the three-dimensional environment without updating the pose vector.

Additionally or alternatively, in some examples, the electronic device detects the pose vector in at least a first dimension of movement. Additionally or alternatively, in some examples, the electronic device detects the pose vector in at least a second dimension of movement different from the first dimension. Additionally or alternatively, in some examples, the electronic device detects the pose vector in at least a pitch dimension. Additionally or alternatively, in some examples, the electronic device detects that the user of the electronic device is in a reclined state when both the first vector and the second vector are aligned at an upward angle relative to gravity. Additionally or alternatively, in some examples, in accordance with a determination that the user of the electronic device is in a reclined state, the electronic device moves the display of virtual content in the three-dimensional environment in accordance with the second vector irrespective of the first vector.

Additionally or alternatively, in some examples, the method further comprises: in response to detecting the change in the first vector or the second vector: in accordance with a determination that the second vector does not satisfy a criterion of the one or more first criteria: in accordance with a determination that an angle between the first vector and the pose vector exceeds a threshold: repositioning the pose vector of the electronic device in accordance with the first vector; and moving the display of virtual content to a third position within the three-dimensional environment, different from the first position and the second position, with a third predefined spatial relationship to the pose vector; and in accordance with a determination that the angle between the first vector and the pose vector is less than the threshold, continuing to display virtual content in the first position within in the three-dimensional environment without updating the pose vector.

Therefore, according to the above, some examples of the disclosure are directed to a method, at an electronic device in communication with one or more display devices and one or more input devices: detecting, via the one or more input devices, a trajectory of a user of the electronic device in a three-dimensional environment; in accordance with a determination that the trajectory of the user satisfies one or more first criteria: displaying, via the one or more display devices, virtual content in a first position within in the three-dimensional environment, wherein the first position is constant with respect to the trajectory of the user; while displaying the virtual content in the first position: tracking, using the one or more input devices, a first vector indicative of the trajectory of the user of the electronic device; and in accordance with a determination that the first vector satisfies one or more second criteria, transitioning the virtual content to a second position different from the first position in accordance with rotation of the user in the three-dimensional environment.

Additionally or alternatively, in some examples, the method further comprises, while displaying the virtual content in the first position, in accordance with a determination that the first vector satisfies one or more third criteria, including a criterion required by both the one or more second criteria and the one or more third criteria, transitioning the virtual content to a third position different from the second position in accordance with the rotation of the user in the three-dimensional environment. Additionally or alternatively, in some examples, the criterion required by both the one or more second criteria and the one or more third criteria is satisfied when an angle between the first vector and a second vector indicative of a user orientation of the electronic device is less than a threshold angle.

Additionally or alternatively, in some examples, transitioning the virtual content to the third position includes moving the virtual content in the three-dimensional environment in accordance with the trajectory of the user and in accordance with rotation of the user in the three-dimensional environment for a predetermined duration and after the predetermined duration since transitioning the virtual content to the third position, transitioning the virtual content to the first position. Additionally or alternatively, in some examples, transitioning the virtual content to the third position includes moving the virtual content in the three-dimensional environment in accordance with the trajectory of the user and in accordance with rotation of the user in the three-dimensional environment while a rate of change of the trajectory of the user is less than a threshold angle over a second predetermined duration, greater than the predetermined duration.

Additionally or alternatively, in some examples, the one or more second criteria include a criterion that is satisfied when an angle between a current value of the first vector and a respective previous value of the first vector in the first position is greater than a first threshold angle. Additionally or alternatively, in some examples, the method further comprises: while displaying the virtual content in the first position: in accordance with a determination that the first vector satisfies one or more third criteria, including a criterion that is satisfied when the angle between the current value of the first vector and the respective previous value of the first vector in the first position is greater than a second threshold angle for a predetermined period of time, transitioning the virtual content to a third position different from the second position in accordance with the rotation of the user in the three-dimensional environment. Additionally or alternatively, in some examples, the first threshold angle is greater than the second threshold angle. Additionally or alternatively, in some examples, the method further comprises: while displaying the virtual content in the second position: in accordance with a determination that the first vector satisfies one or more third criteria, including a criterion that is satisfied when an angle between a current value of the first vector and a respective previous value of the first vector is less than a predefined threshold angle, transitioning the virtual content to the first position.

Some examples of the disclosure are directed to an electronic device, comprising: one or more processors; memory; and one or more programs stored in the memory and configured to be executed by the one or more processors, the one or more programs including instructions for performing any of the above methods.

Some examples of the disclosure are directed to a non-transitory computer readable storage medium storing one or more programs, the one or more programs comprising instructions, which when executed by one or more processors of an electronic device, cause the electronic device to perform any of the above methods.

Some examples of the disclosure are directed to an electronic device, comprising one or more processors, memory, and means for performing any of the above methods.

Some examples of the disclosure are directed to an information processing apparatus for use in an electronic device, the information processing apparatus comprising means for performing any of the above methods.

The foregoing description, for purpose of explanation, has been described with reference to specific examples. However, the illustrative descriptions above are not intended to be exhaustive or to limit the disclosure to the precise forms disclosed. Many modifications and variations are possible in view of the above teachings. The examples were chosen and described in order to best explain the principles of the disclosure and its practical applications, to thereby enable others skilled in the art to best use the disclosure and various described examples with various modifications as are suited to the particular use contemplated.

1. A method comprising:
at an electronic device in communication with one or more display devices and one or more input devices:
detecting, via the one or more input devices, a pose vector of the electronic device, wherein detecting the pose vector includes detecting a first vector and a second vector associated with a user of the electronic device;
displaying, via the one or more display devices, virtual content in a first position within in a three-dimensional environment with a predefined spatial relationship relative to the pose vector; and
moving, via the one or more display devices, the virtual content to a second position within the three-dimensional environment based on a relationship between the first vector and the second vector.

2. The method of claim 1, wherein moving the virtual content to a second position within the three-dimensional environment based on a relationship between the first vector and the second vector includes:
while displaying the virtual content in a first position with the predefined spatial relationship relative to the pose vector, detecting a change in the first vector or the second vector;
in response to detecting the change in the first vector or the second vector:
in accordance with a determination that the first vector and the second vector satisfy one or more first criteria:
updating the pose vector of the electronic device in accordance with the detected change in the first vector or the second vector;
moving the display of virtual content to a second position within the three-dimensional environment, different from the first position, with the predefined spatial relationship to the pose vector; and
in accordance with a determination that the first vector and the second vector do not satisfy one or more first criteria, continuing to display virtual content in the first position within in the three-dimensional environment without updating the pose vector.

3. The method of claim 2, further comprising:
in response to detecting a change in the first vector or the second vector:
in accordance with a determination that the second vector does not satisfy a criterion of the one or more first criteria:
in accordance with a determination that an angle between the first vector and the pose vector exceeds a threshold:
repositioning the pose vector of the electronic device in accordance with the first vector; and
moving the display of virtual content to a third position within the three-dimensional environment, different from the first position and the second position, with a third predefined spatial relationship to the pose vector; and
in accordance with a determination that the angle between the first vector and the pose vector is less than the threshold, continuing to display virtual content in the first position within in the three-dimensional environment without updating the pose vector.

4. The method of claim 1, wherein detecting the second vector associated with the user of the electronic device includes detecting an orientation of a torso of the user when stationary.

5. The method of claim 1, wherein the electronic device detects the pose vector in at least a pitch dimension.

6. The method of claim 5, wherein the electronic device detects that the user of the electronic device is in a reclined state when both the first vector and the second vector are aligned at an upward angle relative to gravity.

7. The method of claim 5, further comprising:
in response to detecting a change in the first vector or the second vector:
in accordance with a determination that the second vector does not satisfy a criterion of one or more first criteria:
in accordance with a determination that an angle between the first vector and the pose vector exceeds a threshold:
repositioning the pose vector of the electronic device in accordance with the first vector; and
moving the display of virtual content to a third position within the three-dimensional environment, different from the first position and the second position, with a third predefined spatial relationship to the pose vector; and
in accordance with a determination that the angle between the first vector and the pose vector is less than the threshold, continuing to display virtual content in the first position within in the three-dimensional environment without updating the pose vector.

8. An electronic device, comprising:
one or more display devices;
one or more input devices;
one or more processors;
memory; and
one or more programs, wherein the one or more programs are stored in the memory and configured to be executed by the one or more processors, the one or more programs including instructions for performing:
detecting, via the one or more input devices, a pose vector of the electronic device, wherein detecting the pose vector includes detecting a first vector and a second vector associated with a user of the electronic device;
displaying, via the one or more display devices, virtual content in a first position within in a three-dimensional environment with a predefined spatial relationship relative to the pose vector; and
moving, via the one or more display devices, the virtual content to a second position within the three-dimensional environment based on a relationship between the first vector and the second vector.

9. The electronic device of claim 8, wherein moving the virtual content to a second position within the three-dimensional environment based on a relationship between the first vector and the second vector includes:
while displaying the virtual content in a first position with the predefined spatial relationship relative to the pose vector, detecting a change in the first vector or the second vector;
in response to detecting the change in the first vector or the second vector:
in accordance with a determination that the first vector and the second vector satisfy one or more first criteria:
updating the pose vector of the electronic device in accordance with the detected change in the first vector or the second vector;
moving the display of virtual content to a second position within the three-dimensional environment, different from the first position, with the predefined spatial relationship to the pose vector; and
in accordance with a determination that the first vector and the second vector do not satisfy one or more first criteria, continuing to display virtual content in the first position within in the three-dimensional environment without updating the pose vector.

10. The electronic device of claim 9, the instructions further comprising:
in response to detecting the change in the first vector or the second vector:
in accordance with a determination that the second vector does not satisfy a criterion of the one or more first criteria:
in accordance with a determination that an angle between the first vector and the pose vector exceeds a threshold:
repositioning the pose vector of the electronic device in accordance with the first vector; and
moving the display of virtual content to a third position within the three-dimensional environment, different from the first position and the second position, with a third predefined spatial relationship to the pose vector; and
in accordance with a determination that the angle between the first vector and the pose vector is less than the threshold, continuing to display virtual content in the first position within in the three-dimensional environment without updating the pose vector.

11. The electronic device of claim 8, wherein detecting the second vector associated with the user of the electronic device includes detecting an orientation of a torso of the user when stationary.

12. The electronic device of claim 8, wherein the electronic device detects the pose vector in at least a pitch dimension.

13. The electronic device of claim 12, wherein the electronic device detects that the user of the electronic device is in a reclined state when both the first vector and the second vector are aligned at an upward angle relative to gravity.

14. The electronic device of claim 12, the instructions further comprising:
in response to detecting a change in the first vector or the second vector:
in accordance with a determination that the second vector does not satisfy a criterion of one or more first criteria:
in accordance with a determination that an angle between the first vector and the pose vector exceeds a threshold:
repositioning the pose vector of the electronic device in accordance with the first vector; and
moving the display of virtual content to a third position within the three-dimensional environment, different from the first position and the second position, with a third predefined spatial relationship to the pose vector; and
in accordance with a determination that the angle between the first vector and the pose vector is less than the threshold, continuing to display virtual content in the first position within in the three-dimensional environment without updating the pose vector.

15. A non-transitory computer-readable storage medium storing one or more programs, the one or more programs comprising instructions, which, when executed by an electronic device with one or more display devices, and an input device, cause the electronic device to perform:
detecting, via the one or more input devices, a pose vector of the electronic device, wherein detecting the pose vector includes detecting a first vector and a second vector associated with a user of the electronic device;
displaying, via the one or more display devices, virtual content in a first position within in a three-dimensional environment with a predefined spatial relationship relative to the pose vector; and
moving, via the one or more display devices, the virtual content to a second position within the three-dimensional environment based on a relationship between the first vector and the second vector.

16. The non-transitory computer-readable storage medium of claim 15, wherein moving the virtual content to a second position within the three-dimensional environment based on a relationship between the first vector and the second vector includes:
while displaying the virtual content in a first position with the predefined spatial relationship relative to the pose vector, detecting a change in the first vector or the second vector;
in response to detecting the change in the first vector or the second vector:
in accordance with a determination that the first vector and the second vector satisfy one or more first criteria:
updating the pose vector of the electronic device in accordance with the detected change in the first vector or the second vector;
moving the display of virtual content to a second position within the three-dimensional environment, different from the first position, with the predefined spatial relationship to the pose vector; and
in accordance with a determination that the first vector and the second vector do not satisfy one or more first criteria, continuing to display virtual content in the first position within in the three-dimensional environment without updating the pose vector.

17. The non-transitory computer-readable storage medium of claim 16, further causing the electronic device to perform:
in response to detecting the change in the first vector or the second vector:
in accordance with a determination that the second vector does not satisfy a criterion of the one or more first criteria:
in accordance with a determination that an angle between the first vector and the pose vector exceeds a threshold:
repositioning the pose vector of the electronic device in accordance with the first vector; and
moving the display of virtual content to a third position within the three-dimensional environment, different from the first position and the second position, with a third predefined spatial relationship to the pose vector; and
in accordance with a determination that the angle between the first vector and the pose vector is less than the threshold, continuing to display virtual content in the first position within in the three-dimensional environment without updating the pose vector.

18. The non-transitory computer-readable storage medium of claim 15, wherein the electronic device detects the pose vector in at least a pitch dimension.

19. The non-transitory computer-readable storage medium of claim 18, wherein the electronic device detects that the user of the electronic device is in a reclined state when both the first vector and the second vector are aligned at an upward angle relative to gravity.

20. The non-transitory computer-readable storage medium of claim 18, further causing the electronic device to perform:
in response to detecting a change in the first vector or the second vector:
in accordance with a determination that the second vector does not satisfy a criterion of one or more first criteria:
in accordance with a determination that an angle between the first vector and the pose vector exceeds a threshold:
repositioning the pose vector of the electronic device in accordance with the first vector; and
moving the display of virtual content to a third position within the three-dimensional environment, different from the first position and the second position, with a third predefined spatial relationship to the pose vector; and
in accordance with a determination that the angle between the first vector and the pose vector is less than the threshold, continuing to display virtual content in the first position within in the three-dimensional environment without updating the pose vector.
